(19) United States
(12) Patent Application Publication
(10) Pub. No.: US 2009/0103984 A1
(43) Pub. Date: Apr. 23, 2009

(54) Gas subsea transmission system and submersible suspension pressure-equaliser pipeline

(76) Inventor: Kasra Zarisfi, (US)

Correspondence Address: Kasra Zarisfi, 46, Aboyne Road, Garthdee, Aberdeen, AB10 7BY, GB

(21) Appl. No.: 11/907,833

(22) Filed: Oct. 18, 2007

(51) Int. Cl. F16L 1/12; F16L 57/02

(52) U.S. Cl. 405/168.1; 137/236.1

(57) ABSTRACT

Gas Subsea Transmission System (GSTS) is a new method for transferring large quantities of natural gas between marine distances through the oceans. Its purpose is to provide a safer, faster and more financially advantageous alternative to gas transmission via LNG.

The GSTS's main part is a Submersible Suspension Pressure-equaliser Pipeline (SSPP). It is a long pipe with a large diameter which has a high capacity of gas transmission. This pipe is kept submersible and suspended in deep waters by its special mooring system. It is made from steel pipe which is reinforced by internal concrete rings.

The basic concept of SSPP is to cancel the internal pressure of the gas pipeline with the external hydrostatic water pressure by varying the pipe environment. These conditions lead to the possibility of a large diameter pipeline resulting in efficient, high capacity gas transmission. SSPP mooring system is able to change the pipe level to the right depth base on the changes in gas pressure and equalise the external and internal pressures.

The GSTS has offshore stations that separate the SSPP into shorter segments. The pipe can be operated, maintained, installed and inspected from these points. During normal operation, these offshore stations are capable of staying submerged under water. This design feature means that they would be protected from adverse surface conditions.

### CROSS-REFERENCE TO RELATED APPLICATION

Not Applicable

### STATEMENT REGARDING FEDERALLY SPONSORED RESEARCH OR DEVELOPMENT

Not Applicable APPENDIX

Not Applicable

### BACKGROUND OF THE INVENTION

Not Applicable

### BRIEF SUMMARY OF THE INVENTION

Not Applicable

### DRAWINGS

45 figures in 21 pages are attached.

### OATH OR DECLARATION

Declaration form is attached.

### SEQUENCE LISTING

Not Applicable

### BRIEF DESCRIPTION OF THE SEVERAL VIEWS OF THE DRAWING

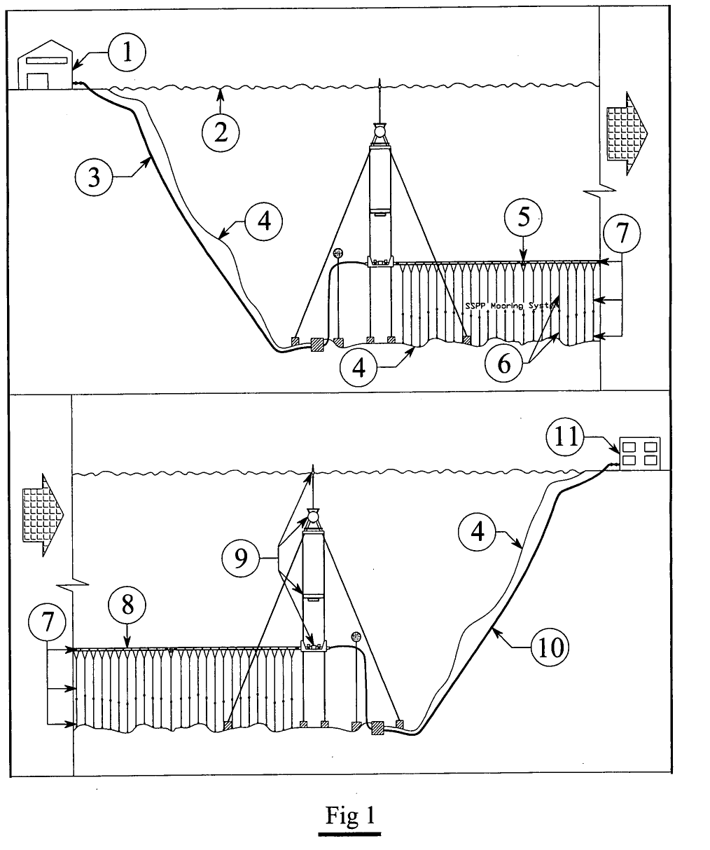

FIG. 1 It is Gas Subsea Transmission System (GSTS) with its Components. 1—Coastal Feeding Compressor station 2—Sea Surface 3—Feeding Branch 4—Seafloor 5—Primary Station 6—SSPP Mooring System 7—Submersible Suspension Pressure-equaliser Pipeline (SSPP) 8—SSPP Body 9—Offshore Station 10—Consuming Branch 11—Coastal consuming Valve Station

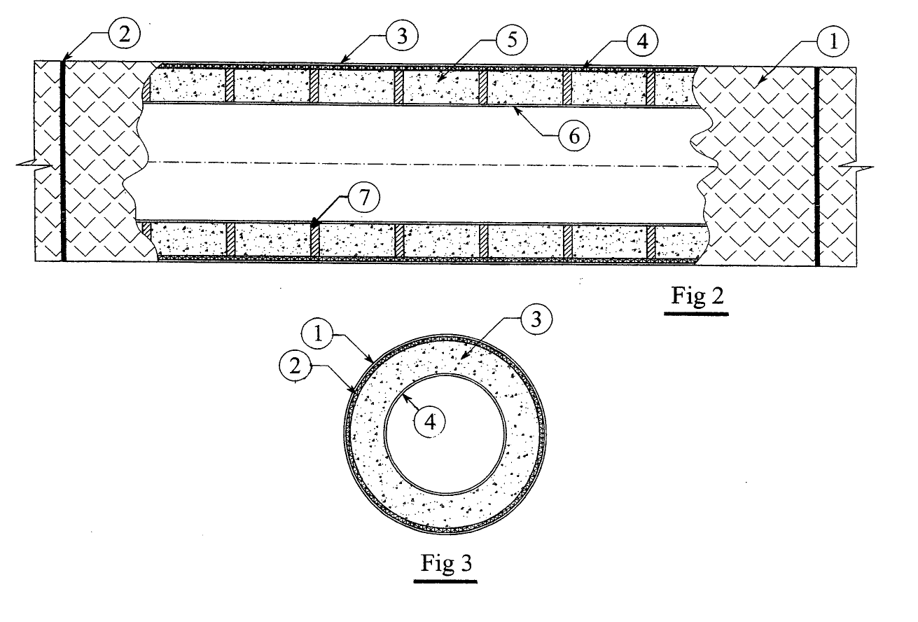

FIG. 2 It is a partial cross section of SSPP body. 1—SSPP Body 2—Welding Joint between the Pipe Elements 3—External Coating 4—Steel pipe 5—Concrete ring 6—Internal Coating 7—Polymeric Layer between Concrete Rings

FIG. 3 It is a radial cross section of concrete cylinder. 1—External Coating 2—Steel pipe 3—Concrete ring 4—Internal Coating

FIG. 4 An installed SSPP which has a Y cable arranging (a specific length of pipe has a set of mooring system). 1—Seafloor 2—Sea Surface 3—SSPP 4—Suspension Length 5—Mooring Cable 7—Top Ballast 8—Chain Ballast 9—Base Ballast

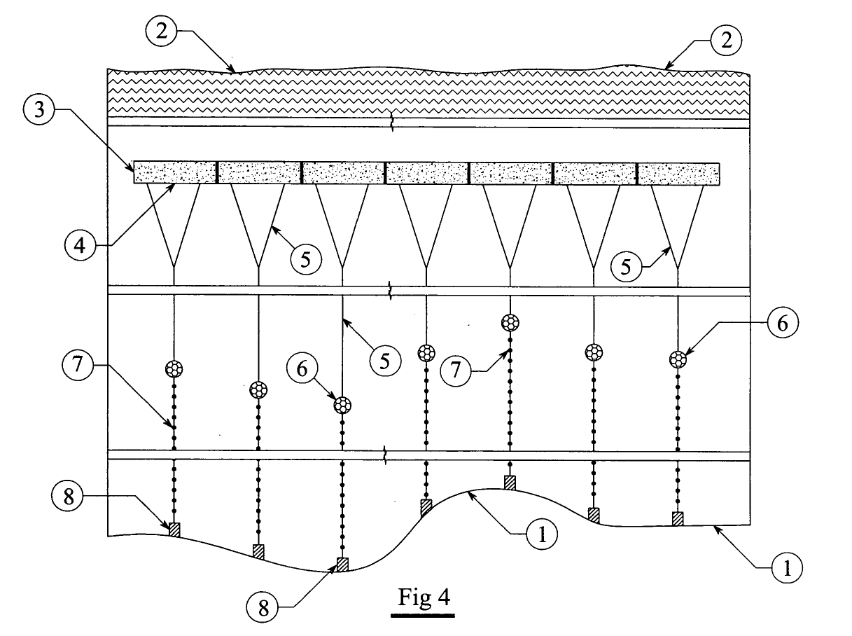

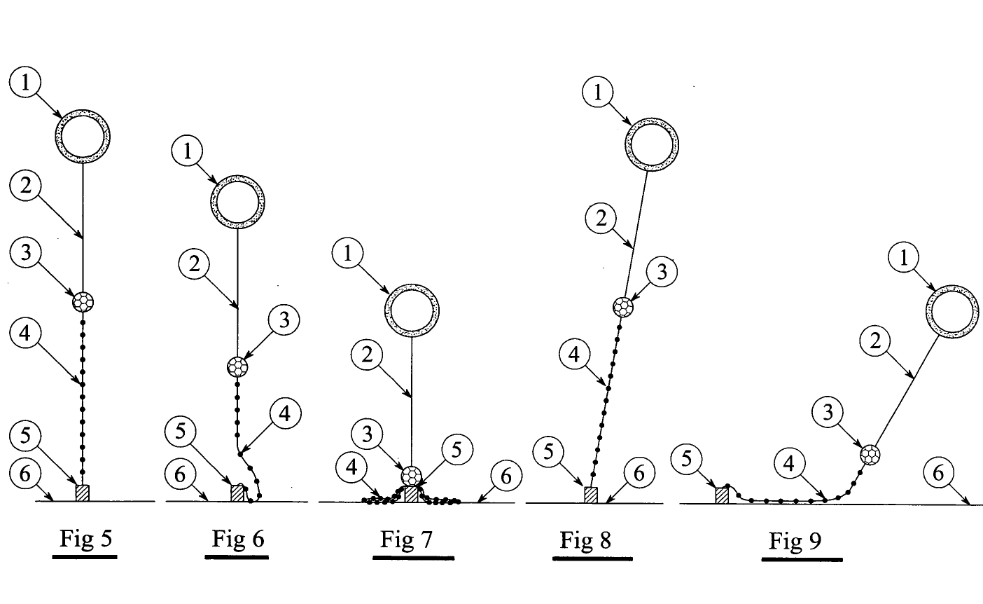

FIGS. 5 to 9

1—SSPP 2—Mooring Cable 3—Top Ballast 4—Chain Ballast 5—Based Ballast 6—Seafloor

FIG. 5 SSPP in its normal operating level (gas normal operating pressure) and some part of chain ballast sits on seafloor and remain part is submersible.

FIG. 6 SSPP in its highest operating level (gas lowest operating pressure) and chain ballast is completely stretched.

FIG. 7 SSPP in its lowest operating level (gas highest operating pressure) and chain ballast is completely sits on seafloor.

FIG. 8 SSPP in its highest operating level while a horizontal current applies a force on SSPP.

FIG. 9 SSPP in its lowest operating level while a horizontal current applies a force on SSPP.

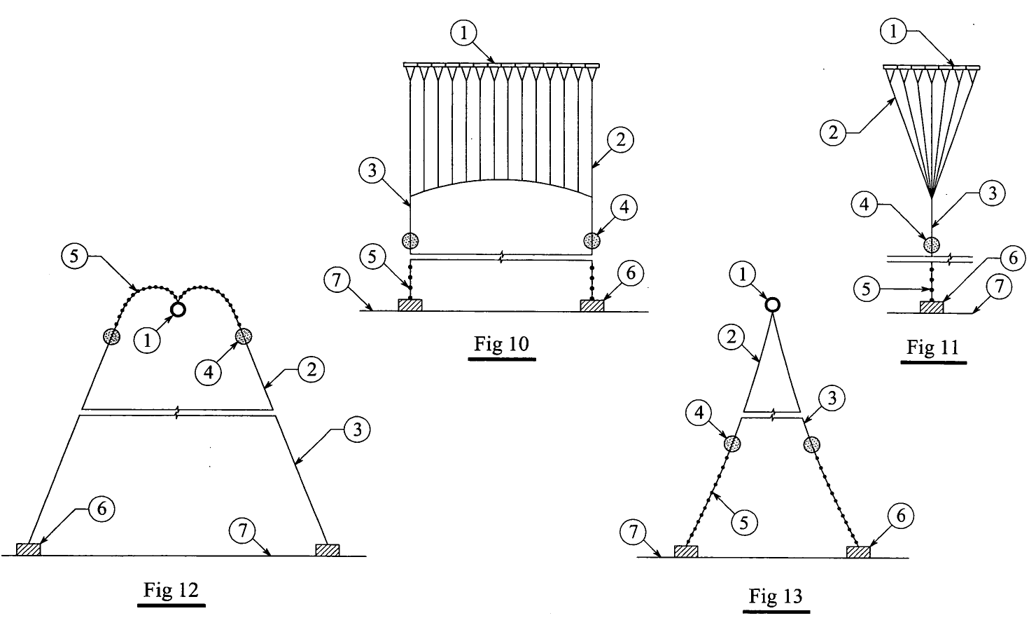

FIG. 10 Bridge cable arrangement, can be used when the seafloor is very deep. 1—SSPP 2—Mooring Cable 3—King Cable 4—Top Ballast 5—Chain Ballast 6—Base Ballast 7—Seafloor

FIG. 11 Bundle cable arrangement, can be used when the seafloor is very deep. 1—SSPP 2—Mooring Cable 3—King Cable 4—Top Ballast 5—Chain Ballast 6—Base Ballast 7—Seafloor

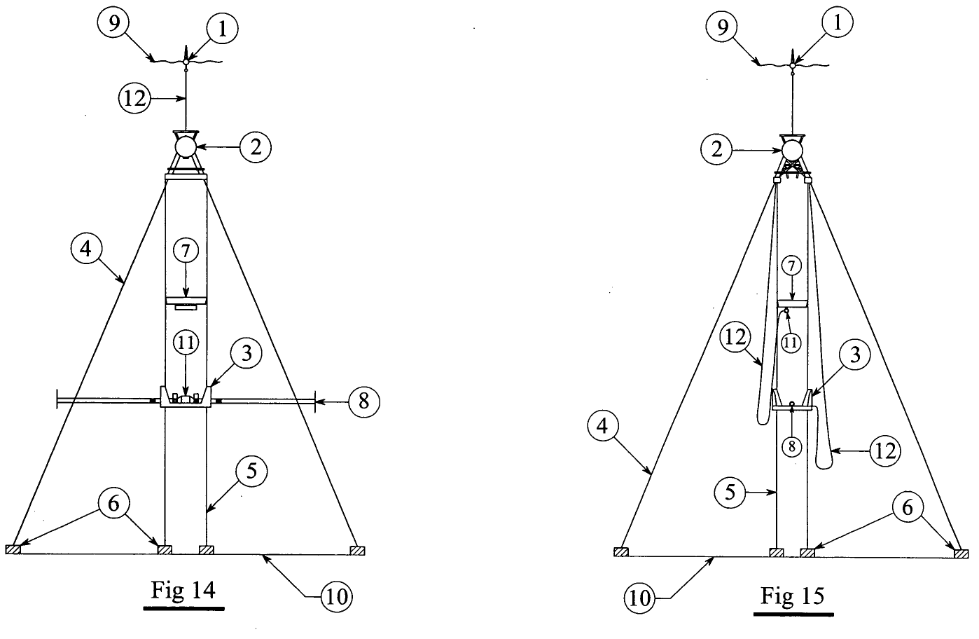

FIG. 12 Centipede cable arrangement, can be used the same as FIG. 13. In this case mooring system has some buoys instead of chain and top ballasts. It equalises internal and external pressure with the same base as chain ballast but vice versa. 1—SSPP 2—Lateral Mooring Cable 3—Lateral King Cable 4—Top Buoy (instead of top ballast) 5—Chain Buoy (instead of chain ballast) 6—Base Ballast 7—Seafloor

FIG. 13 Centipede cable arrangement can be used when the seafloor is very deep and there is a lateral current with high velocity (more than 0.5 m/s) around SSPP. 1—SSPP 2—Mooring Cable 3—King Cable 4—Top Ballast 5—Chain Ballast 6—Base Ballast 7—Seafloor

FIG. 14 A side view of offshore station. The view plate is parallel to the SSPP 1—Floating Module 2—Command Module 3—Operating Module 4—Lateral Mooring Cable (Mooring Pyramid's Lateral Edge) 5—Centeral Mooring Cable (Mooring Pyramid's Height) 6—Mooring Weight 7—Special Lift 8—SSPP 9—Sea surface 10—Seafloor 11—Operating module Equipments (Middle Cylinder, Compressor, Block valve) 12—Flexible Riser between Floating and Command Modules

FIG. 15 A side view of offshore station. The view plate is perpendicular to the SSPP 1—Floating Module 2—Command Module 3—Operating Module 4—Lateral Mooring Cable (Mooring Pyramid's Lateral Edge) 5—Centeral Mooring Cable (Mooring Pyramid's Height) 6—Mooring Weight 7—Special Lift 8—SSPP 9—Sea surface 10—Seafloor 11—Middle Cylinder (while it is being carried up) 12—Flexible Riser between Command Module and Operating Module

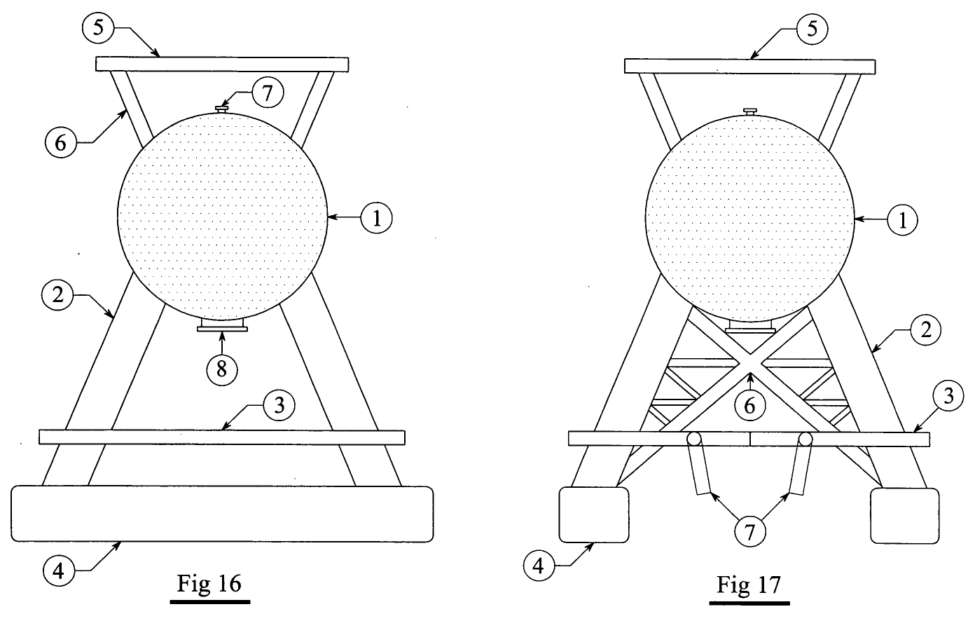

FIG. 16 A simple side view of the offshore station's command module. The view plate is parallel with the SSPP 1—Centeral Sphere 2—Structure (Main Column) 3—External Open Workshop 4—Pontoon 5—Helipad 6—Structure (Helipad Supports) 7—Top Entrance 8—Bottom Entrance

FIG. 17 A simple side view of the offshore station's Command module from its side. The view plate is perpendicular with the SSPP 1—Centeral Sphere 2—Structure (Main Column) 3—External Open Workshop 4—Pontoon 5—Helipad 6—Structure (Trusses) 7—External Workshop's Gate

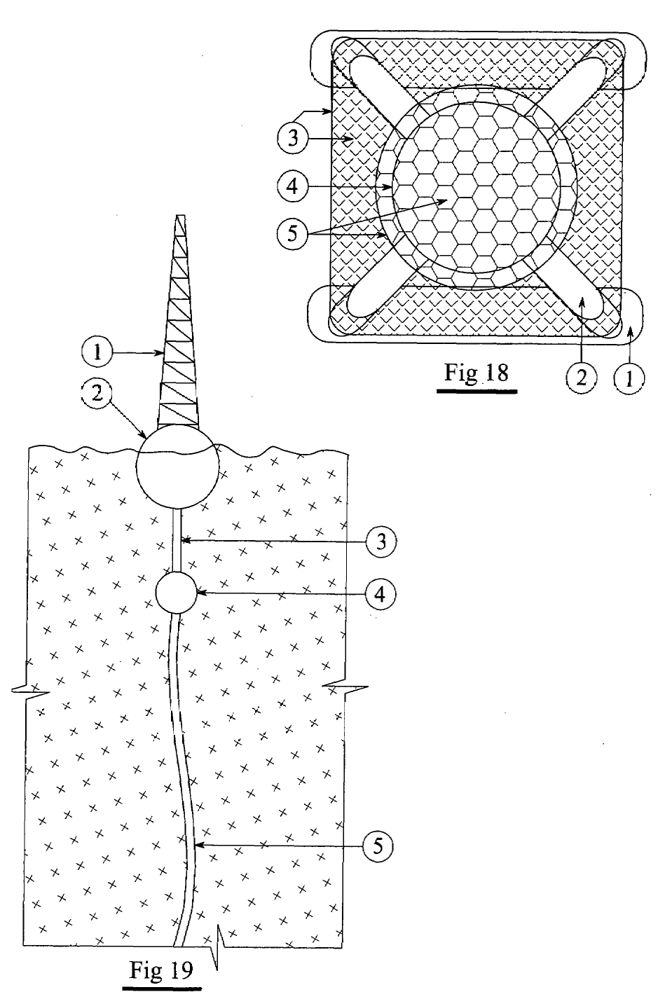

FIG. 18 Top view of offshore station's command module. 1—Pontoon 2—Structure (Main Column) 3—External Open Workshop 4—Centeral Sphere 5—Helipad

FIG. 19 Offshore station floating module 1—Derrick 2—Flaoting Sphere 3—Connecting Beam 4—Weight 5—Flexible Riser between the floating module and the command module

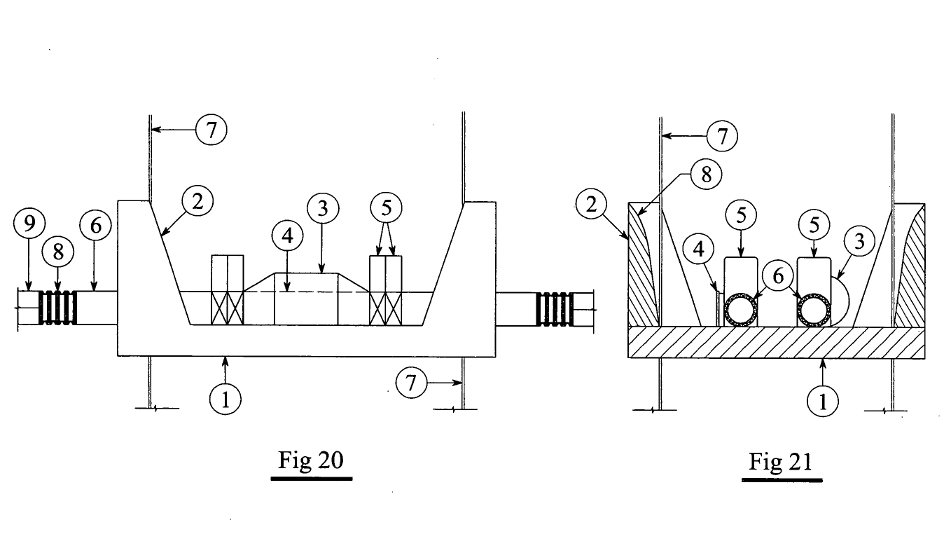

FIG. 20 A side view of offshore station's operating module. The view plate is parallel to the SSPP 1—Operating Module Casing Floor (The Equipments Sitting Area) 2—Casing Column 3—Middel Cylinder (Which Has Compressor) 4—Middle Cylinder 5—Block Valves 6—Y Branch 7—Centeral Mooring Cable 8—Y Branch Flexible Part 9—SSPP

FIG. 21 A cross section of offshore station's operating module. The crossing plate is perpendicular to the SSPP 1—Operating Module Casing Floor (The Equipment Sitting Area) 2—Casing Column 3—Middel Cylinder (Which Has Compressor) 4—Middle Cylinder (Which Has Branch) 5—Block Valves 6—Y Branch 7—Centeral Mooring Cable 8—Column Leading Edge

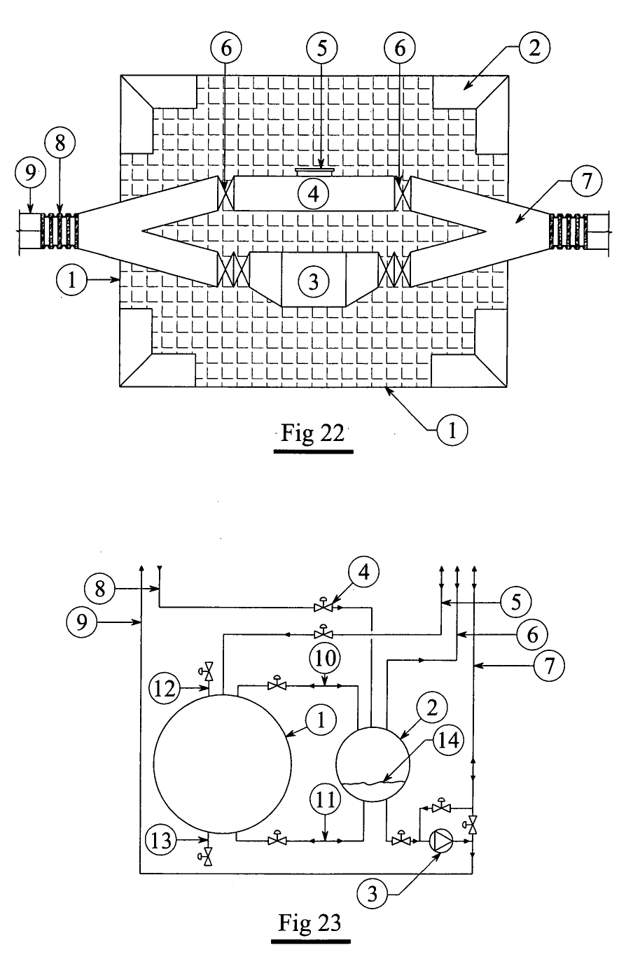

FIG. 22 A top view of the offshore station's Operating Module. 1—Operating Module Floor (The Equipment Sitting Area) 2—Casing Column 3—Middel Cylinder (Which Has Compressor) 4—Middle Cylinder 5—Branch Connection 6—Block Valves 7—Y Branch 8—Y Branch Flexible Part 9—SSPP

FIG. 23 Schematic of the middle cylinder and the flaring system lines and connections. 1—Middle Cylinder 2—Two Phase Separator 3—High Pressure Pump (Reciprocating Pump) 4—Control Valves 5—Feeding Line (Riser) 6—Low Pressure Gas Line (Riser) 7—Liquid Line (Riser) 8—SSPP Internal Line (Vacuum Absorber Line) 9—SSPP Internal Line (Inhibitor Injector) 10—Gas Line between Middle Cylinder and Two Phase Separator 11—Liquid Line between Middle Cylinder and Two Phase Separator 12—Middle Cylinder Gas Line to the Environment (Sea Water) 13—Middle Cylinder Liquid Line to the Environment (Sea Water) 14—Liquid Level in Two Phase Separator

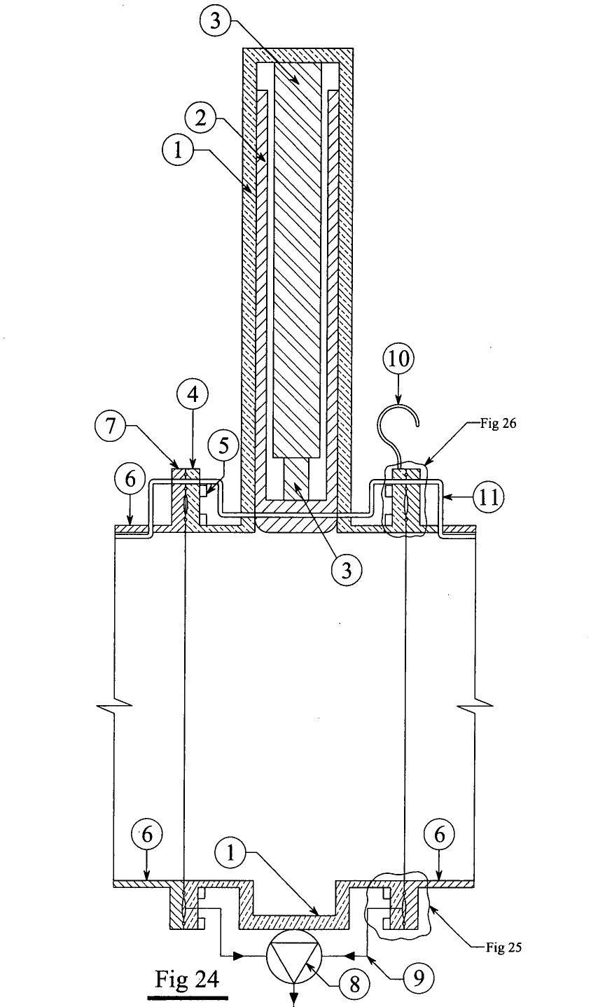

FIG. 24 A cross section of the controllable block valve while it is fixed between the middle cylinder and the Y branch. When the flanges are connected together, the hollow space between them is full of water so the suction line and the bump should be at the bottom of the valve to send out the water properly. The needle should be at the top of the valve and has a big tail to be accessible. 1—Block Valve Casing 2—Gate 3—Hydrolic Jack (Servo Motor) 4—Block Valve Flange 5—Electrical Magnet 6—Other Equipment (Middle Cylinder or Y branch) 7—Middle Cylinder's or Y branch's Flange 8—Suction Pump 9—Suction line 10—Top Needle 11—SSPP Internal Line (Vacuum or Injector line)

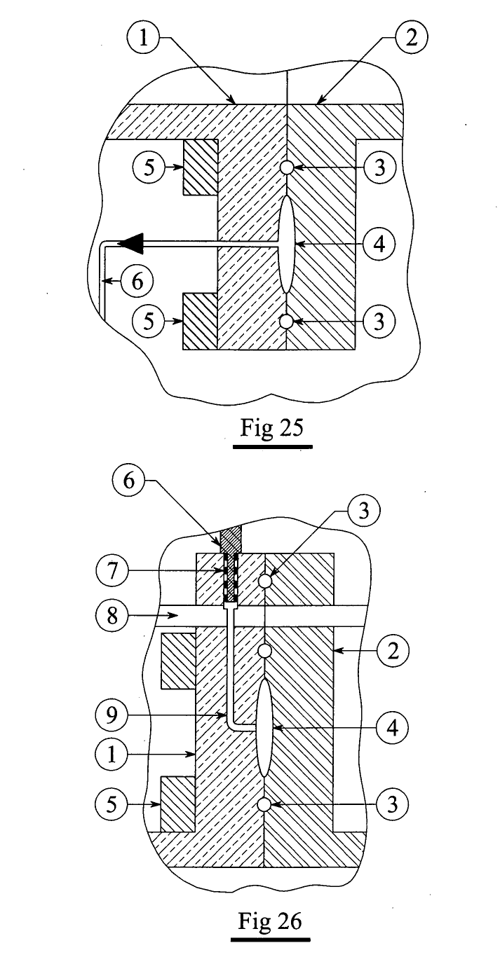

FIG. 25 A cross section at the bottom of the block valve flange. 1—Block Valve Flange 2—Middle Cylinder's or Y branch's Flange 3—Sealing Ring (O Ring) 4—Hollow Space between Flanges 5—Electrical Magnet 6—Suction Line

FIG. 26 A cross section at the top of the block valve flange. 1—Block Valve Flange 2—Middle Cylinder's or Y branch's Flange 3—Sealing Ring (O Ring) 4—Hollow Space between Flanges 5—Electrical Magnet 6—Flange's Top Needle 7—Needle's Seal 8—SSPP Internal Line (Vacuum or Injector line) 9—Vacuum Releasing Line

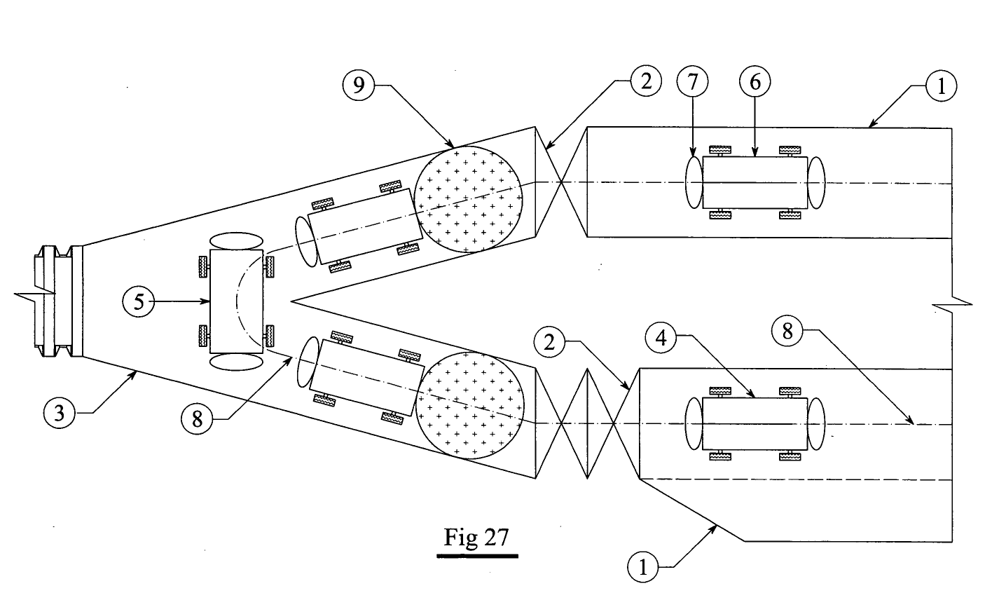

FIG. 27 This figure shows a schematic movable block valve. It is a vehicle which can move through the middle cylinder and Y branch. If a block valve is broken down while it is close the vehicle can be introduced from the other middle cylinder, turns in Y branch, goes behind the damaged valve and blocked the line. 1—Middle Cylinder 2—Block Valve 3—Y Branch 4—Movable Block Valve (In the middle cylinder) 5—Movable Block Valve (While it is passing through the Y branch) 6—Movable Block Valve's Vehicle 7—Movable Valve's Balloon (When it is not pressurised) 8—Middle Cylinder's and Y branch's Central Axis 9—Movable Valve's Balloon (When it is pressurised)

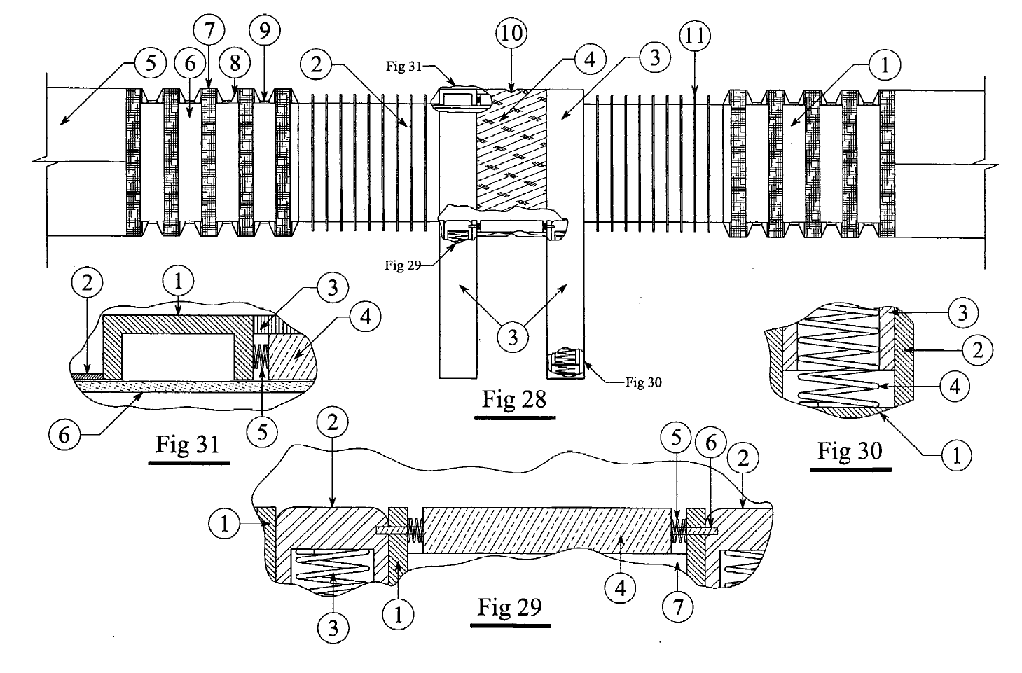

FIG. 28 Schematic of the primary station. The leakage system, instrumentation package, safety valves are not shown in this figure. 1—Lateral Pipe Flexible Part 2—Lateral Pipe Rigid Part 3—Block Valve 4—Middle Ring 5—SSPP 6—Rigid Jointing Segment 7—Flexible joint 8—Stiffener 9—Buckling Arrestor 10—Groove (weakness point) in Middle Ring 11—Stiffener and Buckling Arrestor

FIG. 29 Cross section of the block valves and the middle ring and it shows that how the gates are locked by the weight ring pins. 1—Block Valve Casing 2—Gate 3—Compressed Spring (Top) 4—Weigh Ring 5—Weight Ring Spring 6—Locking Pin

FIG. 30 The bottom cross section of the block valve casing and shows that how the spring can be compressed and fixed between the gate and the casing. The gate structure has an internal space which can contain the spring. 1—Casing Bottom 2—Casing wall 3—Gate 4—Compressed Spring (Bottom)

FIG. 31 Top cross section of block valve casing. The Internal lines in this area (crossing the valve) are made from a brittle polymer so the gate can break these lines when it is being closed. 1—Casing Top 2—Lateral Pipe Rigid Part 3—Middle Ring 4—Weight Ring 5—Weight Ring Spring 6—SSPP Internal Line

FIG. 32 The usage of the primary stations in the installation phase. The primary segments are pulled from their both ends to be stretched during transportation. Obviously the front tugboat pulls the system stronger than the back tugboat therefore whole system moves toward the front boat. 1—Front Tugboat 2—Front Tugboat Pulling Cable 3—Front Connector Beam 4—SSPP Primary segment 5—Back Connector Beam 6—Back Tugboat Stretching Cable 7—Back Tugboat

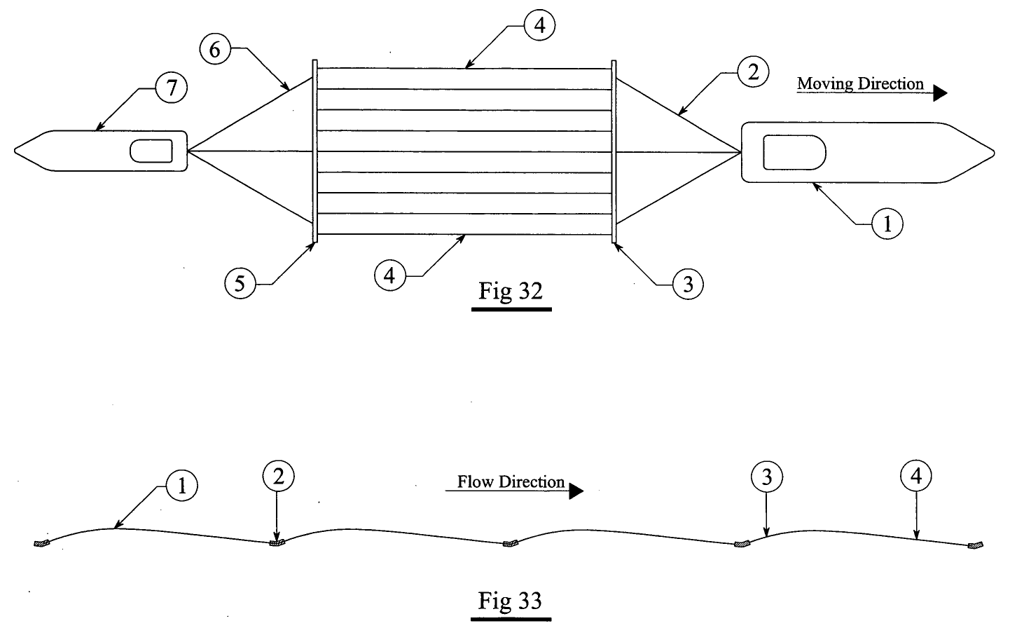

FIG. 33 This figure shows the SSPP slop. The second slop is lower than the first one because the gas flow helps the liquids to move. 1—SSPP 2—Primary Station 3—SSPP First Slop 4—SSPP Second Slop

FIG. 34 The top view of the operating module which has a branch. The jointing nipples are sat under the middle cylinders to connect it to the Y branch. 1—Operating module 2—Middle Cylinder 3—Joining Nipple 4—Branch Block Valve 5—Branch Y Branch 6—Branch Riser

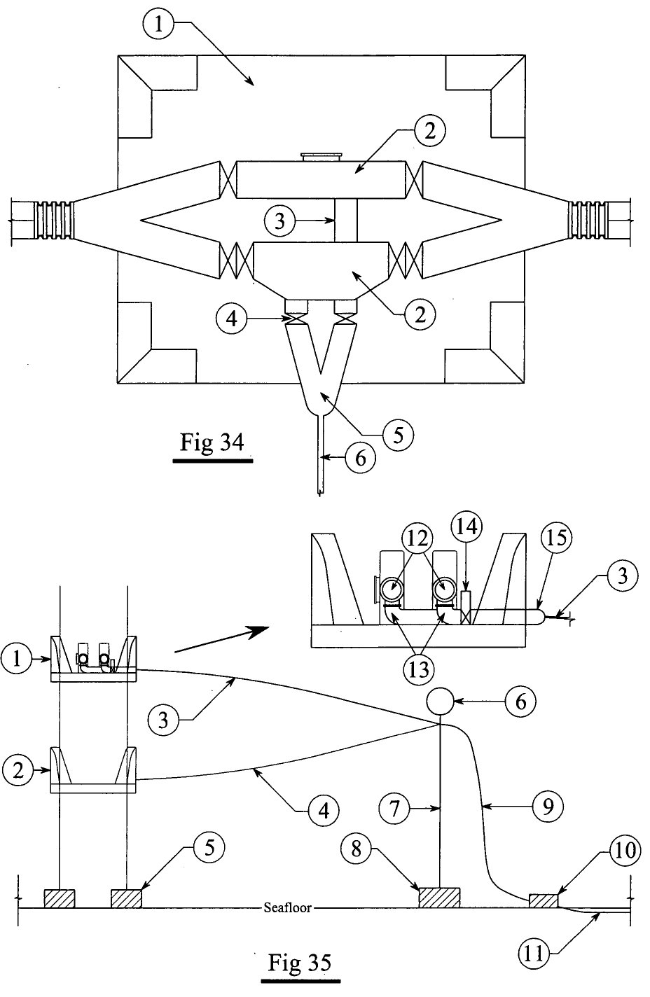

FIG. 35 This fig shows a branch which is connected to the operating module. The branch's submersible part is designed to have the same density as seawater in the average operating pressure. 1—Operating module (In the highest operating level) 2—Operating module (In the lowest operating Level) 3—Branch's line Submersible Part (the gas pressure less than average) 4—Branch's line Submersible Part (the gas pressure higher than average) 5—The Station Mooring Weight 6—Buoy 7—Cable 8—Weight 9—Branch Riser 10—Branch Anchoring Point 11—Branch Line Buried Part

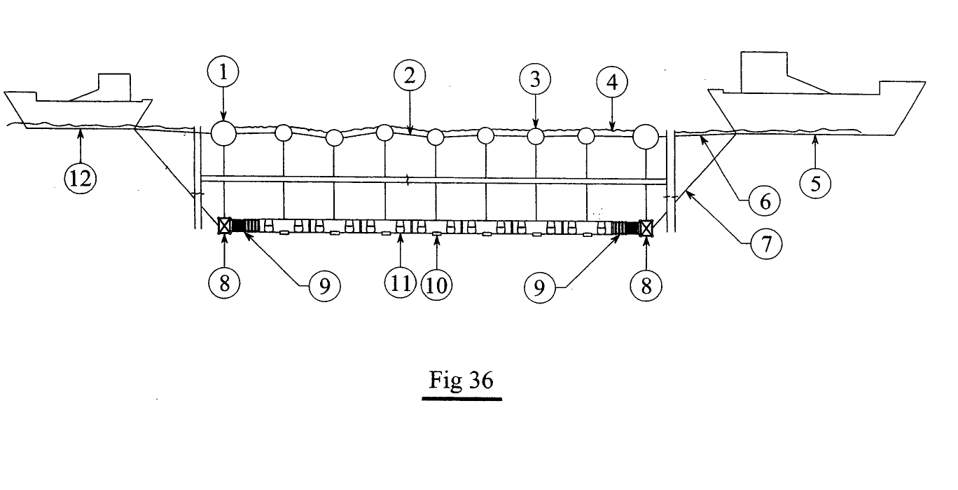

FIG. 36 This fig shows a part of SSPP which is being carried by a tugboat while all installation tools are fixed to it. 1—Beam and Primary Station Buoy (Bigger than the Others) 2—Strong Chain or Cable between Buoys 3—Installation Tool Buoy 4—Sea Surface 5—Front Tugboat 6—Buoys Front Pulling Cable 7—SSPP Front Pulling Cable 8—Conector Beam 9—Primary Station 10—Ballast Package 11—Installation Tool Package 12—Back Tugboat

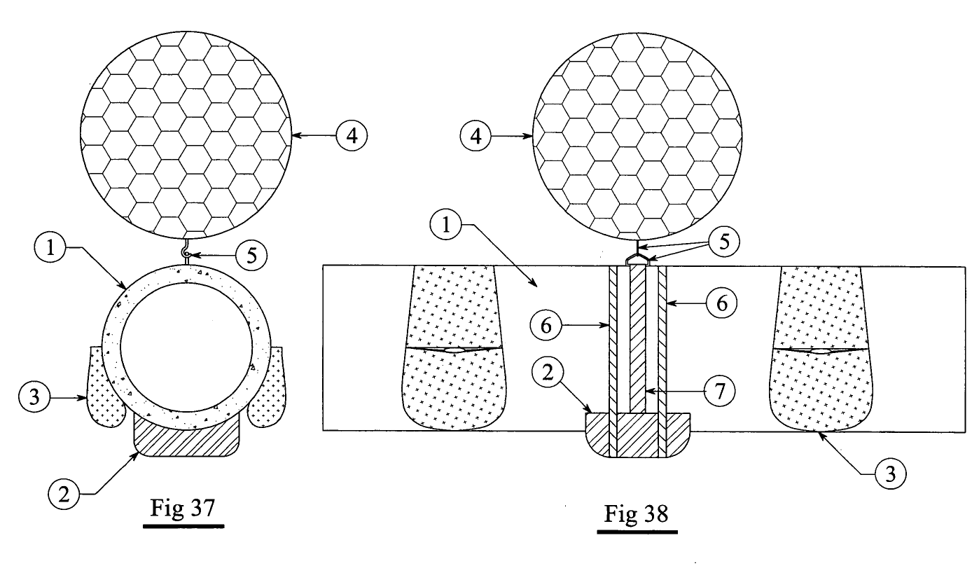

FIG. 37 A cross section of an SSPP in the factory while all installation tools are fixed to it. 1—SSPP 2—Ballast Package 3—Installation tool Package (Sack and chain) 4—Installation Tool Buoy 5—Buoy's Joint

FIG. 38 Side view of an SSPP in the factory with all installation tools fixed to it. 1—SSPP 2—Ballast Package 3—Installation tool Package 4—Installation Buoy 5—Buoy's Joint 6—The Ribbon Which Fixes the Ballast Package 7—The Ribbon Which Fixes Buoy's Cable

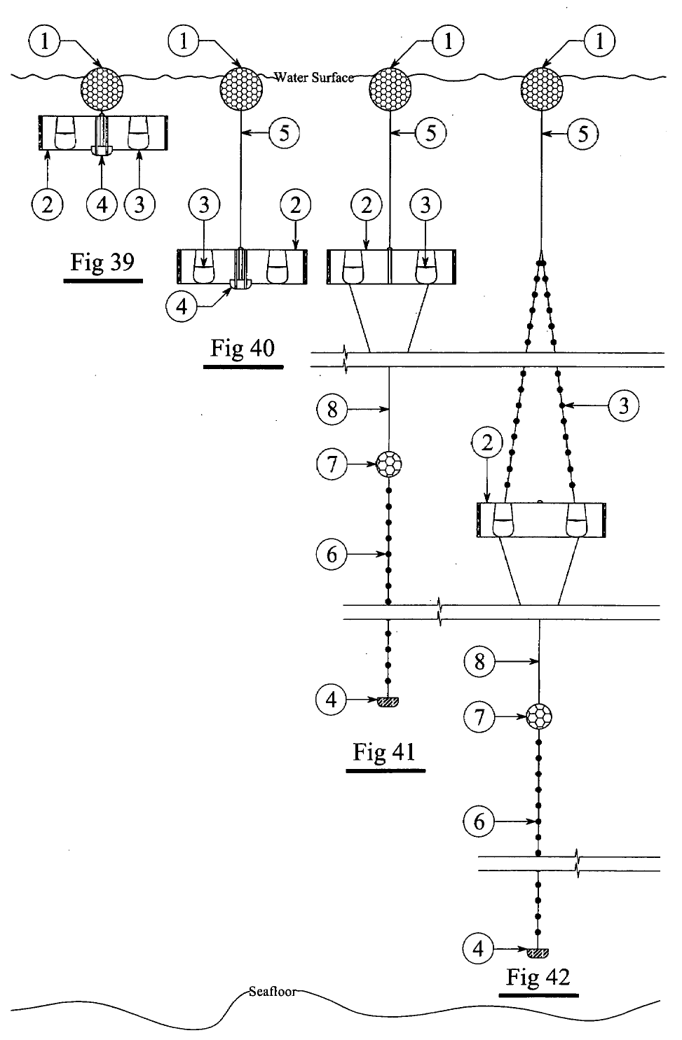

FIG. 39 SSPP with its installation tools when it is moved in the factory. The installation buoys are joined to the pipe 1—Installation Buoy 2—SSPP 3—Instalation tool Package 4—Ballast Package

FIG. 40 SSPP with its installation tools when it is being carried in sea or oceans (after the factory's offshore platform). The installation buoys are separated from the pipe and the cables are stretched completely between the buoys and the pipe. 1—Installation Buoy 2—SSPP 3—Instalation tool Package 4—Ballast Package 5—Buoy Cable

FIG. 41 The SSPP segment has been installed between two offshore stations and its mooring system package has been released to the water. 1—Installation Buoy 2—SSPP 3—Installation tool Package 4—Base Ballast 5—Buoy Cable 6—Chain Ballast 7—Top Ballast 8—SSPP Mooring Cable

FIG. 42 The SSPP installation package has been released and the pipe is being filled by gas. 1—Installation Buoy 2—SSPP 3—Instalation tool Chain 4—Base Ballast 5—Buoy Cable 6—Chain Ballast 7—Top Ballast

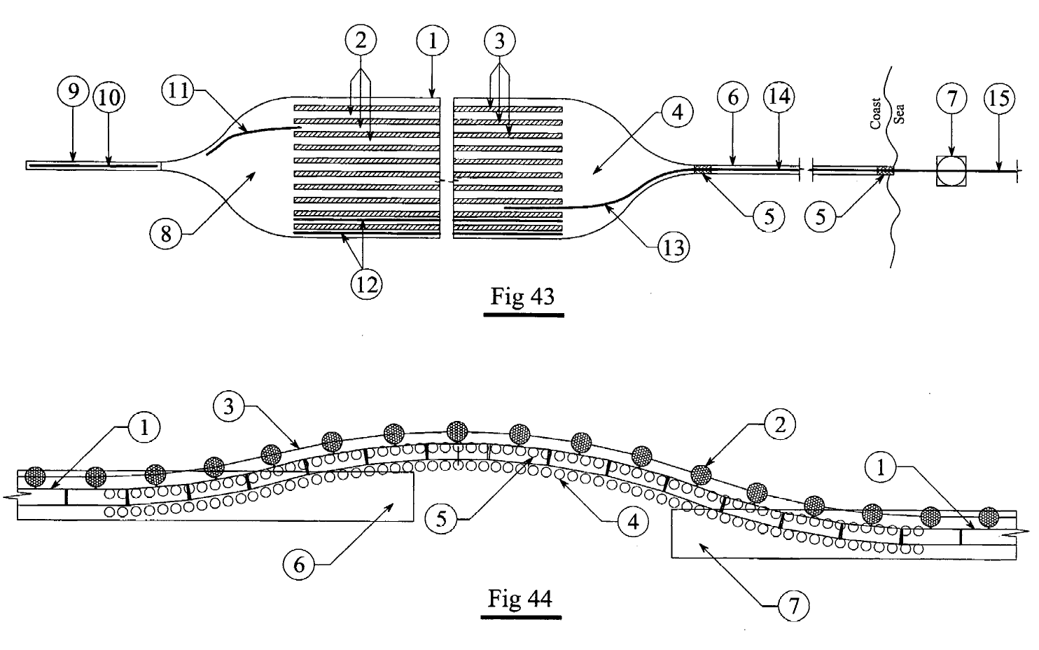

FIG. 43 This fig shows a top view of the SSPP suggested construction factory. 1—Construction Area 2—Construction Canals 3—Construction Platforms 4—First leading Lake 5—Sending Machine 6—Sending Canal 7—Offshore Sending Platform 8—Second Leading Lake 9—Testing Pipe 10—Piece of SSPP in Test 11—Piece of SSPP carrying for test 12—Ready SSPP primary segment 13—SSPP Passing Through Leading Lake 14—SSPP Passing Through Sending Cannel 15—SSPP Sinking to the Sea

FIG. 44 Side view of the sending machine. This machine carries the pipe between the leading lake and sending canal, the sending cannel sections, the sending canal and the sea and the offshore platform and the sea. 1—SSPP 2—Installation Balloons 3—Cable between Buoys 4—Sending Machine Wheels (First Floor) 5—Sending Machine Wheels (Second Floor) 6—Sending Canal or First Leading Lake (In Higher Elevation) 7—Lower Level Sending Canal or Sea (In Lower Elevation)

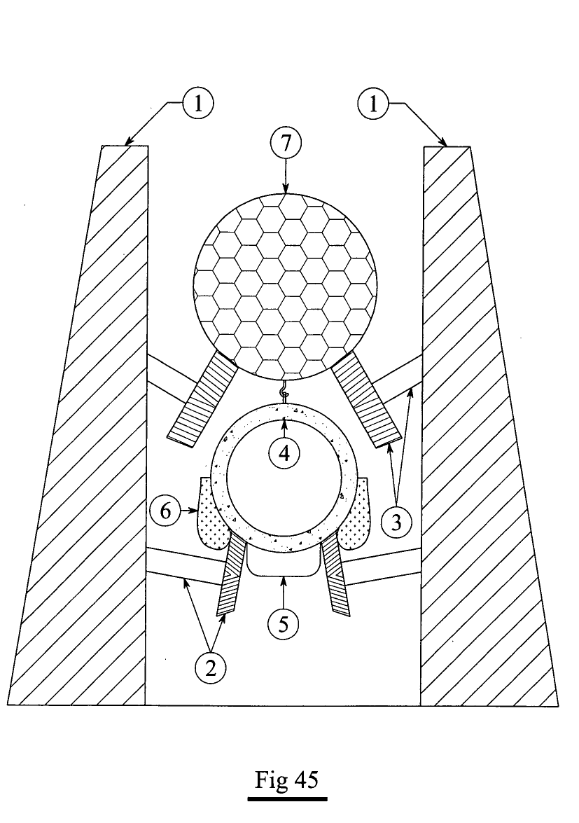

FIG. 45 Cross section of a sending machine. It has two decks (floor) one for passing the pipe and the other for passing the installation balloons. 1—Sending Machine's Structure 2—Sending Machine Wheels (First Floor) 3—Sending Machine Wheels (Second Floor) 4—SSPP 5—Ballast Package 6—Installation Package 7—Installation Buoy

### DETAILED DESCRIPTION OF THE INVENTION

### Introduction to Gas Subsea Transmission System & Submersible Suspension Pressure-Equaliser Pipeline

Table of Contents

Chapter 1 . . . 10

Submersible, Suspension, Flexible Pipelines . . . 10
1-1 Introduction . . . 10
1-2 SSPP Gas Transmission . . .12
   1-2-1) Finding the Flow Regime . . . 13
   1-2-2) Length Estimation . . . 14
1-3 SSPP Components . . . 15
   1-3-1) SSPP Body . . . 15
   1-3-2) SSPP Mooring System . . . 17
1-4 SSPP Stability . . . 19
   1-4-1) Marine Currents . . . 19
   1-4-2) Base and Top ballasts Weight . . . 20
   1-4-3) Weight Calculations for the Chain Ballast . . . 22
   1-4-4) SSPP Horizontal and Vertical Displacement Base on Environmental Loads . . . 25
   1-4-5) SSPP Wall Thickness . . . 27
   1-4-6) Mooring Cable Design . . . 32
   1-4-7) Earthquake and Seismic Activity . . . 34
1-5 SSPP General Notifications . . . 36
   1-5-1) Gas Composition . . . 36
   1-5-2) Gas Pressure in the Pipe . . . 36
   1-5-3) Pipe Failure . . . 37
   1-5-4) Leakage in the Pipe . . . 37
   1-5-5) Vortex Induced Vibration . . . 38
   1-5-6) SSPP Connection to Offshore Stations . . . 38
   1-5-7) Passing over Sea Ridges and Trenches . . . 39
   1-5-8) Life in Deep Water . . . 39
1-6 Chapter I References . . . 39

GSTS Components . . . 40
2-1 Introduction . . . 40
2-2 GSTS Offshore Stations . . . 41
   2-2-1) Offshore Station Command Module . . . 41
   2-2-2) Offshore Station Operating Module . . . 46
   2-2-3) Offshore Station Floating Module . . . 51
   2-2-4) Offshore Station Systems . . . 52
2-3 Primary Stations . . . 55
   2-3-1) Primary Station Installation Usage . . . 56
   2-3-3) Primary Station Fail Safe System . . . 56
   2-3-4) Primary Station Leakage System . . . 58
   2-3-5) Primary Station Instruments . . . 59
2-4 Branches and Linking Stations . . . 59
   2-4-1) Feeding Stations . . . 60
   2-4-2) Consuming Stations . . . 60
   2-4-3) Feeding and Consuming Branch Lines . . . 60

Chapter III . . . 61

SSPP Installation, Construction and Operation . . . 61
3-1 Introduction . . . 61
   3-2-1) Transportation Phase . . . 63
   3-2-2) Submersion Phase . . . 64
3-3 SSPP Construction . . . 66
   3-3-1) SSPP Construction Coastal Factory . . . 66
   3-3-2) SSPP Construction Process . . . 69
3-4 SSPP Operation . . . 70
   3-4-1) SSPP Capabilities . . . 71
   3-4-2) SSPP Release . . . 71
   3-4-3) SSPP Pigs . . . 72

Conclusion . . . 73

Introduction

The problem of energy supply is one of the most important global issues. Currently most of the world's required energy is harnessed from fossil fuels. It is predicted that in the year 2025, fossil fuels will still provide 87% of the worlds energy (Energy April 2004). However there is great concern about the major pollutants released into the environment via the combustion of fossil fuels which contribute to global warming. Using natural gas, the cleanest fossil fuel as a source of energy is the best feasible solution for our near future. Hence, world demand for natural gas is expected to increase rapidly, it is forecast to become the second largest world source of energy after oil. Although currently gas is transferred through pipelines over thousands of miles of land, seas and oceans are boundaries which high capacity, efficient gas transportation is still effectively limited by. As yet, the only solution provided to break these boundaries is to transfer gas with tankers in the form of LNG (Liquefied Natural Gas) over marine distances. This technology is rapidly expanding due to the increase in demand of natural gas. However, studies have shown that, compared to other modes of transportation, LNG is not the best. Research in the oil and gas industries show that pipelines are the easiest, most efficient and safest way for fuels (especially gas) transportation (Hopkins 2005).

This shows that there is actually a market gap for a gas transportation method over seas and oceans whose performance and advantages could match those of pipelines. The Gas Subsea Transmission System (GSTS) is a system which is especially designed to fulfil these criteria via the transfer of gas between marine destinations by a special pipeline. Despite its differences from usual gas pipelines, it retains all their transfer advantages. The GSTS includes a long Submersible Suspension Pressure-equaliser Pipeline (SSPP) as its main part. It also includes other components such as: coastal stations, offshore stations, primary stations and branch lines. Gas is transferred between supplying and consuming coastal stations by the SSPP which is operated from offshore stations.

The potential of the GSTS as an attractive and feasible gas transportation method across seas and oceans is explored in this work, which comprises of three chapters. The first chapter describes the components, characteristics and feasibility of the SSPP. Other GSTS s′ components are described in Chapter two. In Chapter three, the construction, installation and feasibility of the SSPP are explained. Finally an economical, comparative analysis between the GSTS and LNG transportation is included in Chapter four in order to illustrate that GSTS would be the more cost effective alternative. FIG. 1

Chapter I

Submersible, Suspension, Flexible Pipelines

1-1 Introduction

A gas pipeline's internal pressure is the first basic parameter which applies forces on the pipe and creates stresses in the pipe structure. Therefore most pipeline materials must be made from either steel or materials which have similar high toughness and strength. If this internal pressure did not exist, there would not be a need for advance tough and high strength steel and the pipeline can have thin wall thickness to consume less material. This is the basic reason for considering pipes with different pressure conditions. The Submersible Suspension Pressure-equaliser Pipeline (SSPP) is a pipe which is capable of spanning across the oceans and is kept submersible. Its unique characteristic over other pipelines is that it can cancel out its internal pressure with its surrounding external pressure. For the pipe to be stable in this condition it must firstly cancel its buoyant force and stay suspended in a specific depth of water and secondly, its structure must be flexible enough to tolerate deep sea currant forces. The gas pipeline diameter is another basic, yet important issue. The larger the diameter, the higher the capacity of gas transportation and the more efficient the pipeline will be. Maintaining zero pressure difference allows SSPP to have a larger diameter compared to other pipelines without having to be constrained by stresses. This results in a higher efficiency pipeline.

Although the SSPP can have various specifications for different conditions, a specific SSPP with set parameters has been selected for calculations, illustrations and analyses. The purpose of the calculations is to give a better understanding about the SSPP and its feasibility rather than to provide exact figures for detailed design therefore all the numbers and values which are mentioned in this paper are examples and can be vary.

The specifications of assumed SSPP's are given in Table 1-1. Most of the assumptions are explained in this chapter and the remainder are illustrated in the other chapters. Both SI and Imperial units are used in the calculations.

TABLE 1-1

| Description | SI Unit | Imperial Unit |
|---|---|---|
| Max Gas Flow Rate | 200 million cubic | 7 billion cubic |
| | metre per day | feet per day |
| Min Gas Flow Rate | 100 million cubic | 3.5 billion cubic |
| | metre per day | feet per day |
| SSPP Internal Diameter | 2.5 m (2500 mm) | 100 inches |
| SSPP External Diameter | 3058 mm | 120 inches |
| SSPP Steel Wall Thickness | 10 mm | 0.39 Inches |
| SSPP Concrete Rings Wall | 269 mm | 10.59 Inches |
| Thickness | | |
| Max/Min Internal Pressure | 25/20 MPa | 3700/3000 psig |
| (Gas Pressure) | (250/200 Barg) | |
| Average Internal Pressure | 22.5 MPa | 3350 psig |
| (Gas Pressure) | (225 barg) | |
| Max/Min External Pressure | 25/20 MPa | 3700/3000 psig |
| (Water Hydrostatic pressure) | (250/200 Barg) | |
| Average External Pressure | 22.5 MPa | 3350 psig |
| (Water Hydrostatic pressure) | (225 barg) | |
| SSPP Max/Min Depth | 2500/2000 m | 8200/6560 ft |
| SSPP Average Depth | 2250 m | 7380 ft |
| Seafloor Average Depth | 2800 m | 9184 ft |
| SSPP Whole Length | 8000 km | 5000 miles |
| (Between Supplying and | | |
| Consuming points) | | |
| SSPP Segment Length | 100′000 m | 60 miles |
| (Distance between two | (100 km) | |
| offshore stations) | | |
| SSPP Primary Segment Length | 5000 m | 3 miles |
| (Distance between two primary | | |
| stations) | | |
| SSPP Suspension Length | 60 m | 197 ft |
| (The pipe between two | | |
| mooring connections) | | |
| Mooring Cable Interval Distances | 120 m | 394 ft |
| Mooring Cable Average Length | 800 m | 2440 ft |
| Mooring Cable Diameter | 25 mm | 1 inch |
| Mooring Cable Unit weight | 4 kg/m (39 N/m) | 3 Ibm/ft |
| Internal and External Temperature | 2° C. | 36 F. |
| Sea water Density | 1024 kg/m³ | 80 Ibm/ft³ |
| Deep Water Max Velocity | 0.1 m/s | 0.3 ft/s |
| Deep Water Designing Velocity | 0.3 m/s | 0.9 ft/s |

1-2 SSPP Gas Transmission

The SSPP gas transportation efficiency is one of the issues which must be considered for the pipe feasibility. It is designed to connect between long marine destinations. The SSPP must be able to transfer the gas without compressor stations because in practice, building compressor stations on seas or oceans is not a viable option. However, SSPPs may include some special small compressors installed to increase their gas transmission capacity. The SSPP should also be more efficient than normal pipelines and transfers the gas with a lower pressure drop. Gas flow rate depends on many parameters. The general flow equation of natural gas in a pipe is:

$$Q = π \sqrt{\frac{{g}_{c} \cdot R}{1.856}} \times \frac{{Z}_{b} \cdot {T}_{b}}{{P}_{b}} \times \sqrt{\frac{{P}_{1}^{2} - {P}_{2}^{2} - \frac{58 G \cdot Δ H \cdot {P}_{ave}^{2}}{R \cdot {T}_{ave} \cdot {Z}_{ave}}}{{Z}_{ave} \cdot {T}_{ave} \cdot G \cdot L}} \times \sqrt{\frac{1}{f}} \times {D}^{2.5}$$

(Mohitpour, Golshan et al. 2003) Therefore,

$$Q ∝ \sqrt{\frac{{P}_{1}^{2} - {P}_{2}^{2}}{L}} \times \sqrt{\frac{1}{f}} \times {D}^{2.5}$$

Where

Q=Gas Flow Rate L=Pipe Length

P₁=Upstream Pressure P₂=Downstream Pressure

∫=Friction Factor D=Pipe Internal Diameter

The above proportion shows that if the transmission factor is assumed constant, the flow rate is a direct function of diameter and difference pressure (66 P), but it is an inverse function of length.

Fortunately Length, ΔP and Diameter are not in the same proportion with flow rate. Therefore, if the pipe diameter is increased at a higher pressure, it is possible to transfer high flow rate gas through a long pipe.

The proposed SSPP has a length of 8000 km (5000 miles). This length was chosen because the farthest gas supply and consumption points are within 5000 miles.

In the case where there are no compressor stations, the maximum length of the SSPP which can transfer the minimum gas flow rate (100 mcm/d-3.5 bcf/d) is found and compared with the required length. This is calculated using, all common gas transport equations in pipelines.

1-2-1) Finding the Flow Regime

$$Re = \frac{ρ \cdot D \cdot u}{μ}$$

In this case for natural gas, the actual Re could be found by:

$$Re \approx 45 \cdot \frac{{Q}_{b} \cdot G}{D} = 45 \times \frac{3.5 \times {10}^{9}}{24} \times \frac{0.64}{100} = {42}^{′} {000}^{′} 000$$

(Mohitpour, Golshan et al. 2003)

Nikuradse (fully turbulent)

$$\sqrt{\frac{1}{f}} = 4 {log}_{10} ( 3.7 \frac{D}{{K}_{e}} )$$

### (Mohitpour, Golshan et al. 2003)

Kₑ=0.00156 Inches (smoothed concrete) (White 2003)

(The reason for choosing the concrete is explained later)

$$\sqrt{\frac{1}{f}} = 4 {log}_{10} ( 3.7 \frac{100}{0.00156} ) -> \sqrt{\frac{1}{f}} = 21.5$$

Prandtl-Von Karman (partly turbulent)

$$\sqrt{\frac{1}{f}} = 4 {log}_{10} \frac{Re}{\sqrt{\frac{1}{f}}} - 0.6$$

$$( Mohitpour , Golshan et al . 2003 )$$

$$21.5 = 4 {log}_{10} \times \frac{Re}{21.5} - 0.6 -> Re = {7}^{′} {201}^{′} 756$$

The calculation shows that the actual Re number is larger than transition Re number so the flow regime is fully turbulent

1-2-2) Length Estimation

The most frequently recommended equations high flow rate, high pressure systems with fully turbulent regimes are as follows:

Q_{b}=3.5×10⁹ ft³/day (min gas flow rate)

Tₐᵥₑ=493 R

G=0.64

T_{b}=520 R

P_{b}=14.7 psia

Zₐᵥₑ=1.0

P₁=3700 psig (max pressure in up stream)

P₂=3000 psig (min pressure in down stream)

E=0 (horizontal pipe)

Panhandle B

$${Q}_{b} = 737.02 {{( \frac{{T}_{b}}{{P}_{b}} )}^{1.02} [ \frac{{P}_{1}^{2} - {P}_{2}^{2} - E}{{G}^{0.961} \cdot L \cdot {T}_{ave} \cdot {Z}_{ave}} ]}^{0.510} \cdot {D}^{2.53} \\ ( Mohitpour , Golshan et al . 2003 )$$

$$3.5 \times {10}^{9} = 732.02 {{( \frac{520}{14.7} )}^{1.02} [ \frac{{3700}^{2} - {3000}^{2}}{{0.64}^{0.961} \times L \times 493} ]}^{0.510} \times {100}^{2.53}$$

$$L = 12200 miles$$

$$Weymouth$$

$${Q}_{b} = 432.7 {\frac{{T}_{b}}{{P}_{b}} [ \frac{{P}_{1}^{2} - {P}_{2}^{2} - E}{G \cdot L \cdot {T}_{ave} \cdot {Z}_{ave}} ]}^{0.5} \cdot {D}^{2.667} \\ ( Mohitpour , Golshan et al . 2003 )$$

$$3.5 \times {10}^{9} = 432.7 \times {\frac{520}{14.7} [ \frac{{3700}^{2} - {3000}^{2}}{0.64 \times L \times 493} ]}^{0.5} \times {100}^{2.667}$$

$$L = 13200 miles$$

$$AGA Fully Turbulent$$

$${Q}_{b} = 38.774 {\frac{{T}_{b}}{{P}_{b}} [ \frac{{P}_{1}^{2} - {P}_{2}^{2} - E}{G \cdot L \cdot {T}_{ave} \cdot {Z}_{ave}} ]}^{0.5} [ 4 log \frac{3.7 D}{{K}_{e}} ] \cdot {D}^{2.5} \\ ( Mohitpour , Golshan et al . 2003 )$$

$$3.5 \times {10}^{9} = 38.774 \times \frac{520}{14.7} \times {[ \frac{{3700}^{2} - {3000}^{2}}{0.64 \times L \times 493} ]}^{0.5} \times [ 4 \times log \frac{3.7 \times 100}{0.00156} ] \times {100}^{2.5} \\ L = 10500 miles$$

Since all mentioned fully turbulent equations are empirical, the results could contain errors because the diameter and pressures of SSPP are high and fall outside the range of the equation parameters. However, the founded results are longer than the required length (5000 miles) and the pipe diameter still can be increased if it is required so the probable error can be covered by these points. It should be mentioned that the aim of doing these calculations is not to find exact answers but to show that SSPP with a long length can be used for gas transportation.

If the GSTS has small compressor stations in its offshore stations, not only can the gas transportation feasibility of the system be strongly improved but also the GSTS can transfer the gas between longer destinations (no limitations in theory). It would also have fewer supplying and multiple consuming points. For example, for an offshore station distance of 60 miles (100 km) and with maximum gas flow rate of 200 mcm/d (7 bcf/d), the pressure drop between two stations is about 40 psi (less than 3 bars). This means that a 2M Watts (2000 kilo Watts) compressor (HYSYS 2002) is needed in the offshore station to overcome this pressure drop and transfer the gas with almost constant pressure. A 2M Watt compressor is a small compressor which can be used in offshore stations.

1-3 SSPP Components

The SSPP has two major parts; its body and its mooring system. The body is a reinforced pipe and the mooring system is the part which keeps the pipe submersible. The basics of these parts are introduced here and more detailed information along with design examples are given in the stability section.

1-3-1) SSPP Body

Body structure is formed by thousands of steel pipes which are reinforced by internal concrete rings and there are thin polymeric layers between these concrete parts.

Steel pipe is look like all common steel pipes but it has a large diameter and thin wall thickness. It can have this specification because the stresses are released from its structure. The steel material can chosen from all available carbon steels such as API 5L or duplex etc base on the pipe conditions. A polymeric pipe can also be used as an external pipe instead of the steel pipe.

The concrete rings main purpose is to cancel out the buoyancy force of the pipe however they also resist against compressible stresses. Hence, they are heavy and have a thick wall. The extra weight which is required for submerging can be provided by a simple external concrete coating but internal concrete rings are used to prove the pipe structure. The thin steel pipe can be easily buckled if the pipe is bended due to environmental loads or if an external pressure is applied to the pipe. Concrete has good compressible strength and the rings are thick so they can resist against buckling.

The pipe must be flexible enough to be able to be bended properly due to the environmental loads. Ring shape concrete elements are considered to keep the pipe bending stiffness and not to decrease the flexibility. There are thin polymeric layers between the concrete rings. The polymer is well compressible like a rubber. When the pipe is bended the polymeric layers deform and arrange the concrete rings as the bended pipe shape. The polymeric layer does not let that any hard contact happen between the concrete rings to produce a high concentrated force it can properly distributed the bending force between concrete rings.

Global buckling (lateral or upheaval) is not predicted to involve with SSPP because the whole system is just under tensile forces. There is no reason for a compressible force in the system, the pipe temperature is almost constant therefore no expansion happens in the pipe and if there is an expansion, the pipe can expand free and there is no friction to apply a compressible force on the pipe. In an unpredicted case if a longitudinal compressive force is applied to the pipe the internal concrete rings are protect the pipe structure form buckling failure.

The concrete rings (internal rings) can be reinforced by other material. They also can be made from the other materials such as composites, ceramics, polymers etc but concrete is a good choice for them because it is cheap and also can be cast and formed easily.

It can be suggested that in manufacturing process of SSPP body, the steel pipe be warmed up to expand before the concrete rings be fitted. After steel become cool it stretches and applies a pressure to the concrete rings. In the other world the steel pipe has residual tensile stress and concrete rings have residual compression stress. When the pipe pressurised the steel pipe expands and releases some of the residual stress but the total hoop stress in the steel wall thickness remain constant. This feature can prove fatigue life of the steel pipe.

An external coating protects SSPP from corrosion and other possible damage. The pipe can also be protected by other available methods such as cathodic protection etc. SSPP may have a polymeric internal coating to have a smooth surface. This layer can increase the pipe transportation efficiency. The internal coating is not seal and has some small holes to let the gas pass through it.

If the steel pipe wall thickness is very thin, it is difficult to weld the steel pipes together. Therefore an internal steel ring can be considered at the welding joints to prove the welding process. FIG. 2&3.

1-3-2) SSPP Mooring System

The term “mooring system” is reminiscent of huge complicated systems which make massive offshore floating platforms stable. The mooring system in the SSPP will perform the same function but there are differences between these two systems. Firstly, the offshore platform mooring is a pointed system but the SSPP mooring is a linear system (one tries to fix a point but the other tries to fix a line). Secondly, forces that apply to a platform are much stronger than the forces applying to the SSPP because the marine waves and currents are much stronger on surface than in deep water. The third difference is that a mooring system is designed to fix platforms within a few meters but the SSPP mooring system allows the pipe to move more than hundred metres.

Therefore, a unit of the SSPP mooring system is much smaller and simpler than a platform's mooring. A unit of the mooring system includes cable, base ballast, chain ballast, and top ballast. Cable arranging can be varied, depending on the sea floor depth and lateral current. The most common and simple cable arrangement that can be used in most areas is Y arrangement. In this arrangement, each specific length of the pipe (twice of suspension length 2×60=120 m) is kept submerged from two points located on the bottom of the pipe with two cables. The cables merge together and make one stronger cable. FIG. 4 The end point of this cable connects to the base ballast which is settled on the sea floor. The base ballast is designed to remain fixed on seafloor against highest forces that are applied by the cable. It can be made from reinforced concrete or other materials.

The chain ballast is made from small weights which are connected along the cable. These start from the end of the cable (connection point to the base ballast) and due to the pipe requirement are continued along the cable (500 metres from the cable end point) to the top ballast. The chain ballast can be made from lead or other substances. Its parts can have a continuous shape like chain, or can be separated weights which are connected to the cable at small regular intervals of around one metre. The top ballast is the last weight (the highest) which hangs from the cable. It can be made from lead or other material. During normal operation it is always submersible. FIG. 4

The SSPP's mooring system has two major roles. The first is to keep the pipe submersible and stable in a specified corridor against the loads which apply to the pipe. The corridor has width, height, and length. The width and height of the corridor can reach up to 300-500 metres. Base ballast makes a final upper boundary limit above the pipe against upward and lateral forces (current forces) so the pipe can not move too high up. The boundary is a sector of a circle which the base ballast is the centre and its radius is the cable length when it is fully extended (chain ballast is completely submersible). In practice the pipe will rarely reach to this boundary because upward and lateral forces will move the pipe in direction of the force and pull the cable, also make part of the chain ballast lifted so cable tensile force increases until the cable tensile force cancels out the current applied force. If a downward current applies a force to sink the pipe the chain ballast sits on the sea floor and increases the pipe upward force. This continues till the upward force cancels out the sinking force. The final lower boundary for the sinking pipe is the depth at which the top ballast sits on the sea floor. In this case the ballast's weight is cancelled out with the floor reaction therefore the upward force increases gradually against sinking force and keeps the pipe in its corridors. The fixed and top ballasts are designed with high safety factors because they control the pipe's movement boundaries and if the pipe passes these points there will be nothing to stop it against sinking or floating. While the pipe moves vertically due to an external force in its corridor the external pressure changes the pipe's structure stresses. The pipe is designed to resist against these new conditions.

The second duty of the mooring system is to control the external (hydrostatic) pressure in a way that it stays equal to the pipe internal (gas) pressure.

Suppose a rigid ball (steel ball) is hung from a chain in a deep pool and it is submersible in a specific depth while some part of the chain is sitting on the floor. If some more air is fed to the ball, the ball buoyant force is not changed because it is rigid and there is no change happens in its volume but the air pressure increases, the ball becomes heaver and it's submerge weight (dry weight minus buoyancy) increases so the ball sinks and allows the chain to sit on the floor until the new lifting force (negative submerge weight or buoyancy minus dry weight) becomes equal to the new chain weight. The new equilibrium point is deeper than the old one so the hydrostatic pressure around the ball in this point is higher than the first equilibrium point. The above example shows that an increase in the ball air (internal) pressure produces an increase in the hydrostatic (external) pressure around it.

Therefore if the chain weight per length is a suitable function of air density base on pressure changes, the increase in hydrostatic (external) pressure can be the same as the increase in gas (internal) pressure.

If the internal pressure of the pipe, is changed, the mooring system will change the pipe depth to equalise the external pressure with the new internal pressure. This is facilitated by the chain ballast. If the internal pressure drops, the gas density decreases and the pipe becomes lighter so it rises until further units of chain ballast are lifted and which increases the chain weight. The weight increase cancels the upward pull. The new equilibrium position has higher level and lower hydrostatic pressure than the first equilibrium point so the external pressure is dropped as well. The chain's weight per length is designed based on the variations in gas density so it can compensate for changes in the pipe external and internal pressures and keep them equal. This system helps the pipe to be in the best situation (equal internal and external pressure) and also makes the pipe compatible for using in wide operation ranges due to different conditions. FIG. 5.

1-4 SSPP Stability

SSPP would be submersible in oceans' deep water. They should remain stable in a distinct route during their operating life. Deep water behaviour is not known very well so it is difficult to contemplate all elements and predict their influences on SSPP. Marine currents, biology and human activity are the main factors for SSPP stability, however, deep water current is the most important factor that influences SSPP's stability and it can limit the its use. In the other words SSPP can not be used in deep water currents with very high velocity (more than 1 m/s).

This section shows the basic stability calculations for the design of different elements of a typical SSPP. The calculations data are chosen from table 1-1.

1-4-1) Marine Currents

Marine currents are generated by the thrust of the wind, the spine of earth, moon's and sun's gravity (tides) and changes in water density as a result of the variations in temperature or salinity. There are many types of currents in oceans such as Surface Currents, Deep Water Currents, Thermohaline, Gyres, Upwelling, Downwelling, Spirals etc . . . . But they mostly are very weak or not seen in deep waters (depth of about 2000 meter-6700 feet).

(Duxbury, Duxbury et al. 2000)

Major ocean currents, like Golf Stream, Labrador Current, and Equatorial Currents are surface currents. Golf Stream, the fastest current, has velocity of about 2.5 m/s but it is not extending to the depth of 2000 meter so surface currents should be considered in the pipe installation phase and they do not influence the pipe during its normal operation.

(Couper 1989)

Deep currents sources are Antarctica and Arctic Oceans where the water becomes cold and dense and also its salinity is increased. As a result it sinks to the bottom of the oceans gently. Their speed may reach to 0.2 m/s in some areas temporarily but generally deep water currents have a velocity of few millimetres in second.

(Couper 1989)

The deep water velocity is assumed to 0.3 m/s (designing currant). This velocity is higher than actual current speed and includes some safety factor. Such a current may have never pass over the pipe during its operating life. Therefore, in order to find the pipe real behaviour a current with a maximum velocity of 0.1 n/s (max operating currant) is considered.

1-4-2) Base and Top ballasts Weight

1-4-2-1) Base and Top ballasts Weight Base on Vertical Currents

Upper critical point is the case where the pipe is being operated in its lowest pressure (the chain ballast is fully lifted and the pipe is in its greatest height from the sea bed) while an upward design current (0.3 m/s) applies a force to the pipe. In this case the base ballast weight must be able to cancel out the current's force. FIG. 6.

In lower critical point the pipe is being operated in its highest pressure (the chain ballast is completely relaxed on the sea floor and the pipe is in its lowest height from the sea bed) while a down ward design current (0.3 m/s) applies a force to the pipe. The top ballast weigh always is cancelled out by the pipe upward force (buoyancy force). If it sits on the seafloor its weight will be cancel out by the floor reaction and it will increase the pipe upward force. Therefore in this case the top ballast weight must be able to increase the pipe upward force enough to cancel out the current's force. FIG. 7.

$${W}_{FBW} = {W}_{BBW} = {F}_{CV} = \frac{1}{2} {ρ}_{SeaWater} \cdot {D}_{o} \cdot C \cdot {U}_{CV}^{2} L$$

### (White 2003) Where

W_{FBW}=Base ballast Weight in water (Submerge weight)

W_{BBW}=Top ballast Weight in water (Submerge weight)

F_{CV}=Current's Vertical force

Dₒ=Pipe outside diameter (3.2 m)

C=Drag coefficient=1.2

U_{CV}=Current's Vertical velocity (0.3 m/s)

L=Length of the pipe which connect to one mooring system (twice of suspension length 2×60=120 m)

ρ_{SeaWater}=Sea water density (1030 Kg/m³)

Note: When 0.3 m/s water flow is passing around the pipe the Reynolds number is

$$R = \frac{UD}{v} = \frac{0.3 \times 3.2}{1.12 \times {10}^{- 6}} = 8.5 \times {10}^{5}$$

and in this range of Reynolds number the drag coefficient decreases but in here to be more confident in design the max drag coefficient is used in the calculation) (White 2003)

$${W}_{FBW} = \frac{1}{2} \times 1030 \times 3.2 \times 1.2 \times {0.3}^{2} \times 120 -> {W}_{WBW} = {W}_{BBW} = {F}_{CV} = 21360 N$$

$$or$$

$${W}_{WBW} = {W}_{BBW} = 2180 kg$$

The wieght in air can be founded as

$${W}_{FBD} = {W}_{BBD} = \frac{{ρ}_{B}}{{ρ}_{B} - {ρ}_{SeaWater}} \times {W}_{FBW}$$

### Where

W_{FBD}=Base ballast Wieght in air

W_{BBD}=Top ballast Wieght in air

ρ_{B}=Density of Ballast Material

For a concrete Ballast

$$\begin{matrix}{W}_{FBD} = {W}_{BBD} \\ = \frac{2400}{2400 - 1030} \times 21360 \\ = 37420 N \\ = 3820 Kg\end{matrix}$$

For a concrete Ballast

$$\begin{matrix}{W}_{FBD} = {W}_{BBD} \\ = \frac{11300}{11300 - 1030} \times 21360 \\ = 23500 N \\ = 2400 Kg\end{matrix}$$

For a lead Ballast

1-4-2-2) Base Ballasts' Weight Base on Horizontal Currants

Assuming a lateral current velocity of less than half of the design, and vertical currents of (about 0.15 m/s), and the sea depth of about 2800 m, the following calculations for base ballast show that its weight will be enough for pipe stability against the lateral current. However, vertical currents with higher velocities require heavier base ballast.

The base ballast can have a small pile on the seafloor to avoid the increase in weight, however, by in time the base ballast will be gradually buried into the seafloor its lateral friction will be increased.

When the pipe is in upper critical point and a lateral current applies a force on the pipe, the friction force between Base ballast and seafloor should be greater than the current force.

$${F}_{Friction} \geq {F}_{CH}$$

$${F}_{Friction} = μ {W}_{FBW}$$

$${F}_{CH} = \frac{1}{2} {ρ}_{SeaWater} \cdot {D}_{o} \cdot C \cdot {U}_{CH}^{2} L$$

It was found before that:

$${W}_{FBW} = \frac{1}{2} {ρ}_{SeaWater} \cdot {D}_{o} \cdot C \cdot {U}_{CV}^{2} L$$

### Where

F_{Friction}=Friction Force

F_{CH}=Current's Force Horizontal

ρ=Coefficient of static friction between Base ballast and seafloor

U_{CH}=Current's Horizontal Velocity (can be assumed 0.15 m/s)

$${F}_{Friction} \geq {F}_{CH} \to μ \frac{1}{2} {ρ}_{SeaWater} \cdot {D}_{o} \cdot C \cdot {U}_{CV}^{2} L \geq \frac{1}{2} {ρ}_{SeaWater} \cdot {D}_{o} \cdot C \cdot {U}_{CH}^{2} L \to μ \geq \frac{{U}_{CH}^{2}}{{U}_{CV}^{2}}$$

$$And if μ = 0.3 then {U}_{CH} \leq 0.55 {U}_{CV}$$

1-4-3) Weight Calculations for the Chain Ballast

Chain ballast weight is equal to the difference between highest and lowest gas weight in a pipe length which is connected to one mooring system (twice of suspension length).

W_{ChBW}=(W_{GasMax}−W_{GasMin})×L Where

W_{ChBW}=Chain Ballast Weight in Water (Submerge weight)

W_{GasMax}=Max Gas weight in the pipe per meter

W_{GasMin}=Min Gas weight in the pipe per meter

L=Length of the pipe which connect to one mooring system (twice of suspension length 2×60=120 m)

So the Chain ballast Submerge weight is:

$${W}_{ChBW} = ( {ρ}_{2 G} - {ρ}_{1 G} ) \times \frac{π {D}_{i}^{2}}{4} \times L$$

### Where

ρ_{GasMin}=Gas density in P_{GasMin} Min internal pressure

ρ_{GasMax}=Gas density in P_{GasMax} Max internal pressure

Internal pressure difference should be the same as external pressure difference so

ΔPᵢₙₜₑᵣₙₐₗ=ΔPₑₓₜₑᵣₙₐₗ→(P_{GasMax}−P_{GasMin})=(25 MP−20 MP)=ρ_{Seawater}gΔh

Where Δh is the pipe displacement and it is equal to the chain ballast length. Assuming an ideal gas behaviour for the natural gas, its density will be a linear function of pressure and the chain ballast will have a constant weight per unit length. However, if the equation of state for natural gas is considered as

$$P = \frac{RT}{v - b} - \frac{a}{{v}^{2} + cbv + {db}^{2}}$$

(Sonntag, Borgnakke et al. 1998) chain ballast weight per length cannot be considered constant and it will increase from top to bottom.

Considering natural gas as a 0.95% mole methane and 0.5% mole ethane mixture, based on Peng-Robinson equation of state, its properties are shown in Table 1-2.

TABLE 1-2

| Gas Pressure (Barg) | Gas Density (kg/m³) | Temperature (° C.) |
|---|---|---|
| 200 | 202.64 | 2 |
| 200.1 (200 + 0.1) | 202.73 | 2 |
| 210 | 210.49 | 2 |
| 220 | 217.9 | 2 |
| 230 | 224.92 | 2 |
| 240 | 231.56 | 2 |
| 249.90 (250 − 0.1) | 237.81 | 2 |
| 250 | 237.87 | 2 |

(HYSYS 2002)

Under these conditions for the maximum internal pressure of 250 barg (250×10⁵ Pascal), the minimum internal pressure of 200 barg, the pipe length of 120 m, and the cable diameter of 25 mm, the chain ballast weight will be:

$$\begin{matrix}Δ {P}_{in} = Δ {P}_{ex} \\ = {ρ}_{Seawater} g Δ h \to 5 \times {10}^{6} \\ = 1030 \times 9.8 \times Δ h \to Δ h \\ = 495 m \approx 500 m\end{matrix}$$

$$and$$

$$\begin{matrix}{W}_{ChBW} = ( {ρ}_{2 G} - {ρ}_{1 G} ) \times \frac{π {D}_{i}^{2}}{4} \times L \to {W}_{ChBW} \\ = ( 237.9 - 202.6 ) \times \frac{π \times {2.5}^{2}}{4} \times 120 \to \\ {W}_{ChBW} = 20800 kg \\ = 203670 N\end{matrix}$$

This weight (20800 kg) is not distributed constantly on the whole length (500 m) of the chain.

The change in pressure due to one meter vertical movement of the pipe is

ΔPᵢₙ=ΔPₑₓ=ρ_{Seawater}gΔh→ΔP=1030×9.8×1→ΔP=10094Pα=0.10 Barg

Table 1-2 shows the gas density changes for 0.1 bar change in the pressure. The chain ballast first and last meter weights can be calculated as:

The first meter (top of chain ballast)

$${P}_{1} = 250 bar \to {ρ}_{1} = 237.87 kg \text{/} {m}^{3}$$

$$And$$

$${P}_{2} = 249.9 bar \to {ρ}_{2} = 237.81 kg \text{/} {m}^{3}$$

$$\begin{matrix}{W}_{ChBW} = ( 237.87 - 237.81 ) \times \frac{π \times {2.5}^{2}}{4} \times 120 \to {W}_{ChBW} \\ = 35.3 Kg \text{/} m ( top )\end{matrix}$$

This weight is the Submerge weight of chain ballast first meter (top of chain ballast) and it includes the weight of one meter cable plus added weight. The added weight is a concrete or lead weight which is fixed to the cable to provide the suitable weight for chain ballast.

$${W}_{AddedWet} = {W}_{Total} - {W}_{CableWet}$$

$$\begin{matrix}{W}_{AddedWet} = {W}_{Total} - {W}_{CableWet} \to {W}_{AddedWet} \\ = 35.3 - ( 4 \times \frac{7850 - 1030}{7850} ) \\ = 31.8 Kg \text{/} m ( top )\end{matrix}$$

Its wieght in air for concrete ballast is:

$${W}_{AddedDry} = \frac{2400}{2400 - 1030} \times 31.8 = 55.7 Kg \text{/} m ( top )$$

Its wieght in air for lead Ballast is:

$${W}_{AddedDry} = \frac{11300}{11300 - 1030} \times 31.8 = 35.0 Kg \text{/} m ( top )$$

The last meter (bottom of chain ballast)

$${P}_{1} = 200 bar \to {ρ}_{1} = 202.64 kg \text{/} {m}^{3}$$

$$And$$

$${P}_{2} = 200.1 bar \to {ρ}_{2} = 202.73 kg \text{/} {m}^{3}$$

$$\begin{matrix}{W}_{ChBW} = ( 202.73 - 202.64 ) \times \frac{π \times {2.5}^{2}}{4} \times 120 \to {W}_{ChBW} \\ = 53.0 Kg \text{/} m ( bottom ) \\ {W}_{AddedWet} = 53.0 - ( 4.0 \times \frac{7850 - 1030}{7850} ) \\ = 49.5 Kg \text{/} m ( bottom )\end{matrix}$$

Its wieght in air for concrete ballast is

$${W}_{AddedDry} = \frac{2400}{2400 - 1030} \times 49.5 = 86.7 Kg \text{/} m ( bottom )$$

$$Its wieght in air for lead Ballast is$$

$${W}_{AddedDry} = \frac{11300}{11300 - 1030} \times 49.5 = 54.5 Kg \text{/} m ( bottom )$$

The calculation shows that the last meter of chain ballast with concrete weights must be 31 kg (86.7-55.7) heavier than its first meter.

1-4-4) SSPP Horizontal and Vertical Displacement Base on Environmental Loads

1-4-4-1) Horizontal Displacement

When the pipe is in the highest critical point the pipe cable is 800 m long (500 m as chain ballast and 300 m remain), and the final cable angle and lateral diversion can be found as follow. Lateral current (0.3 m/s) is assumed in the following design calculations.

FIG. 8

$$Tan α = \frac{{F}_{CH}}{{W}_{BBW} + {W}_{ChBW} + {W}_{CableWet}}$$

$$d = ( {L}_{Cable} + {L}_{ChB} ) \times Sin α Where$$

$$α = Cable Angle with vertical Axis$$

$${W}_{ChBW} = Chain Ballast ' s Submerge weight ( 203670 N See the calculations in the Chain Ballast section )$$

$${W}_{CableWet} = Submerge Cable Weight between the pipe and top ballast$$

$$d = Lateral Displacement$$

$${L}_{Cable} = Cable Length between the pipe and top ballast ( 300 m )$$

$${L}_{ChB} = Chain Ballast ' s Length ( 500 m )$$

$${F}_{CH} = \frac{1}{2} \times 1030 \times 3.2 \times 1.2 \times {0.3}^{2} \times 120 \to {F}_{CH} = 21360$$

$${W}_{CableWet} = ( 4.0 \times \frac{7850 - 1030}{7850} ) \times 300 \times 9.8 = 10220$$

$$Tan α = \frac{21360}{21360 + 203670 + 10220} \to α = 5.2 °$$

$$d = 800 \times Sin 5.2 \to d = 72.5 m$$

When the pipe is in the lowest critical point and there is a lateral current, the lateral friction force of base ballast is not a significant factor for the pipe stability because in this position the chain ballast is sitting on the seafloor and it increases the friction force gradually.

However, the pipe lateral displacement is an important issue which must be considered for the pipe flexibility and tensile forces. FIG. 9.

The displacement for the pipe in its lower critical point can be found as:

$$Tan α = \frac{{F}_{CV}}{{W}_{BBW} + {W}_{CableWet}} \\ {d}_{1} = {L}_{Cable} \times Sin α \\ {d}_{2} = \frac{{F}_{CV}}{μ \times {AveW}_{ChBW}} \\ d = {d}_{1} + {d}_{2} Where \\ {d}_{1} = Lateral Displacement due to the cable ’ s angle$$

$${d}_{2} = Lateral Displacement due to chain ballast sliding on seafloor$$

$$d = Total Lateral Displacement$$

$${AveW}_{ChBW} = Average Chain Ballast Weight per meter ( 203670 N / 500 m = 410 N \text{/} m )$$

$$Tan α = \frac{21360}{21360 + 10220} -> α = 34 °$$

$${d}_{1} = 300 \times Sin 34 = -> {d}_{1} = 168 m$$

$${d}_{2} = \frac{21360}{0.3 \times 410} -> {d}_{2} = 174 m$$

$$d = 168 + 174 = 342 Meters$$

1-4-4-2) Vertical Displacement

The pipe vertical movement depends on the chain ballast average weigh. The average is:

AveW_{ChBW}=203670 kg/500 m=410 N/m

The downward or upward force due to the design current (velocity of 0.3 m/s) is founded as: F_{CH}=Current's Force Horizontal=21360 N

So the pipe vertical movement is: 21360/410=52 m

1-4-4-3) SSPP Displacement During the Operation

The above calculation was done based on the design current (velocity of 0.3 m/s) but if the pipe displacements are calculated based on the maximum operating current (velocity of 0.1 m/s) the results are much smaller than the design displacement.

The operating displacements are compared with the design movement in Table 1-3

TABLE 1-3

| | | SSPP Movement - m (feet) | |
|---|---|---|---|
| Maximum Operating | lateral | horizontal | between 8 & 42 |
| Current (0.1 m/s) | | | (26 & 39) |
| | upward | vertical | 5.8 (19) |
| | downward | vertical | −5.8 (−19) |
| Designing | lateral | horizontal | between 72 & 340 |
| Current (0.3 m/s) | | | (240 &1120) |
| | upward | vertical | 52 (172) |
| | downward | vertical | −52 (−172) |

1-4-5) SSPP Wall Thickness

As it explained before SSPP's body made from steel pipes which are fitted with concrete rings. These parts wall thickness are not related together and designed base on different aspects.

1-4-5-1) Steel Pipe Wall Thickness

The steel pipe wall thickness is design base on SSPP longitudinal forces which can be applied to the pipe during the installation and operation. It also can be used to calculate what the maximum allowable different pressure in the pipe is. The calculation shows that a very thin steel pipe can be used in theory but a steel pipe with 10 mm wall thickness is considered here to be more practical. The pipe internal diameter is 3038 mm (see concrete rings wall thickness calculation).

SSPP is modelled by finite element software (Orcaflex 9.1). The analysis shows that the pipe maximum tensile force during operation is 438 kn and it happens where a design currant (0.3 m/s) passes over the pipe. The pipe tensile stress can be calculated as follow.

$${σ}_{T} = \frac{{T}_{I}}{{A}_{Steel}}$$

$$Where$$

$${σ}_{T} = Tensile Stress at Steel pipe$$

$${σ}_{yeald} = Pipe \text{’} s Steel Yield Strength ( 358 Mp - Assumed as API 5 L \times 52 )$$

$${T}_{I} = Installation Tensile Force$$

$$Thus$$

$${σ}_{T} = \frac{438000}{\frac{π ( {3.058}^{2} - {3.038}^{2} )}{4}} -> {σ}_{T} = 4.58 Mp$$

It is about 78 times less than the pipe yield strength, so the pipe is designed with in a high safety factor.

SSPP can be constructed in a costal mill and carried by tugboats through the oceans to be installed in the right place. It is an alternative method that can be used instead of constructing the pipe on a lay barge therefore the pipe must be resist against the installation forces. It means the pipe must not be torn when the tugboats pull it from the costal factory. Tugboats carry the pipe gently with the speed of about 6 m/s (≅20 km/h or ≅12 Knots) and it is assumed that a length of 1000 m (primary segment) is carried by tugboat. In this condition the pipe maximum tensile force can be found as follow.

A Flat-Plate which has the same surface as the pipe's external area is assumed instead of pipe to find the drag (friction) force. The pipe outside diameter is 3.058 m (See concrete rings wall thickness calculations) so the replaced plate width is π×3.2=9.60 m.

$${Re}_{L} = \frac{{ρ}_{Seawater} UL}{μ} -> {Re}_{L} = \frac{1024 \times 3 \times 1000}{1 \times {10}^{- 3}} -> {Re}_{L} = 3.072 \times {10}^{9}$$

### (White 2003).

So the Flat-Plate boundary layer theory in turbulent flow should be used and the theory of rough flat plate flow can not cover this case because roughness parameter

$$( \frac{L}{ɛ} \leq {10}^{- 6} )$$

is too small. (White 2003). The Drag force is:

$$D = \frac{1}{2} {C}_{D} {ρ}_{Seawater} {U}^{2} bL$$

### Where

D=Drag force (it is equal with the pipe's tensile force)

C_{D}=Drag Coefficient

U=Vessels or the pipe speed

L=Length of the pipe segment (1000 m)

b=Flat-Plate width (9.60)

ρ_{SeaWater}=Sea Water Density (can be assumed 1024 Kg/m³)

Drag coefficient can evaluate from below equation

$${C}_{D} = \frac{0.031}{{Re}_{L}^{\frac{1}{7}}} -> {C}_{D} = \frac{0.031}{{( 1.536 \times {10}^{10} )}^{\frac{1}{7}}} -> {C}_{D} = 1.087 \times {10}^{- 3}$$

$$( White 2003 ) Therefore$$

$$D = \frac{1}{2} {C}_{D} {ρ}_{Seawater} {U}^{2} bL -> D = \frac{1}{2} \times 0.001087 \times 1024 \times 36 \times 9.60 \times 1000 -> D = 192342 N$$

But in practice the drag force is much bigger than the found result because many added equipment (ballast and installation tools package-sea chapter 3) are connected to the pipe while it is pulled through the water and they increases the pipe drag coefficient.

$${σ}_{T} = \frac{{T}_{I}}{{A}_{Steel}} Where$$

$${σ}_{T} = Tensile Stress at Steel pipe$$

$${σ}_{yeald} = Pipe \text{’} s Steel Yield Strength ( 358 Mp - Assumed as API 5 L \times 52 )$$

$${T}_{I} = Installation Tensile Force$$

$$Thus$$

$${σ}_{T} = \frac{192342}{\frac{π ( {3.058}^{2} - {3.038}^{2} )}{4}} -> {σ}_{T} = 2.01 Mp$$

It is about 178 times less than the pipe yield strength, so the pipe is designed with in a high safety factor.

The maximum allowable different pressure in the pipe can be calculated as follow.

$${σ}_{yeald} \times 0.6 = \frac{Δ P \times {D}_{o}}{2 t}$$

### Where

σ_{yeald}=Pipe's Steel Yield Strength (358 Mp—Assumed as API 5L X 52)

ΔP=Maximum allowable different pressure

Dₒ=External diameter

t=Wall thickness

Note: a typical design factor (0.6) is considered for this calculation.

$$Δ P = \frac{358 \times 0.6 \times 2 \times 10}{3058} -> Δ P = 1.4 MP or 14 bar$$

The pipe maximum vertical displacements by upward and downward design currents (0.3 m/s) were found as ±52 m before (Table 1-3). Therefore maximum pressure differences due to these displacements are:

Δp=ρgh→Δp=1030×9.8×(±52)=±0.5 Mp=±5 bar

If a general difference pressure of I bar (see leakage in general notification) is considered for the whole SSPP, the maximum pressure difference will be 1+5=6 bar and it is far from of the allowable pressure difference.

1-4-5-2) Concrete Ring Wall Thickness

SSPP wall thickness is designed based on the gas buoyant force instead of the wall stresses. This is because the required thickness to reach the appropriate weight to cancel out the pipe buoyancy is much thicker than the thickness which the pipe needs to withstand against compressible stresses.

The concrete rings wall thickness can be calculated with the following equations base on highest operating pressure (Chain ballast is completely relaxed on sea floor while the top ballast is lifted).

$${W}_{ConcreteWet} + {W}_{SteelWet} + {W}_{GasMax} + {W}_{BBW} + {W}_{CableWet} = {F}_{Buonyancy}$$

$$Where$$

$${W}_{ConcreteWet} = The Concrete Rings Submerge Weight per Pipe Length$$

$${W}_{SteelWet} = Steel Pipe Submerge Weight per Pipe Length ( steel wall t = 10 mm )$$

$${W}_{GasMax} = Max Gas Weight in the Pipe per Pipe Length ( highest pressure )$$

$${W}_{BBW} = Top ballast weight in water per Pipe Length ( Submerge weight ) = ( 2180 / 120 ) Kg$$

$${W}_{CableWet} = Cable Submerge weight per Pipe Length ( The part of cable which is above the top ballast )$$

$${W}_{CableWet} = ( 4 \times \frac{7850 - 1030}{7850} ) \times \frac{300}{120} = 8.7 Kg$$

$${F}_{Buoyancy} = The Gas Buoyancy ( Lifting Force ) per Pipe Length$$

$${W}_{ConcreteWet} = ( \frac{π {D}_{o}^{2}}{4} - \frac{π {D}_{i}^{2}}{4} ) \times ( {ρ}_{Concrete} - {ρ}_{SeaWater} )$$

$${W}_{ConcreteWet} = ( \frac{π {D}_{o}^{2}}{4} - \frac{π {2.5}^{2}}{4} ) \times ( 2400 - 1030 ) = 1076 {D}_{o}^{2} - 6725$$

$${W}_{SteelWet} = \frac{π ( {( {D}_{o} + 2 {t}_{Steel} )}^{2} - {D}_{o}^{2} )}{4} \times ( {ρ}_{Steel} - {ρ}_{Seawater} ) = 214 {D}_{0} + 2.1 kg$$

$${W}_{GasMax} = \frac{π {D}_{i}^{2}}{4} \times {ρ}_{GasMax} = 1167 Kg$$

$${F}_{Buoyancy} = \frac{π {D}_{i}^{2}}{4} \times {ρ}_{SeaWater} = 5053 Kg$$

The required external diameter is:

(1076Dₒ²−6725)+(214Dₒ+2.1)+1167+18.2+8.7=5053→Dₒ=3.038 m=3038 mm

So the pipe wall thickness is:

$$t = \frac{3038 - 2500}{2} -> t = 269 mm$$

The required concrete rings wall thickness is found based on the pipe buoyant force so it can be checked by the rings stresses. As it mentioned before the maximum pressure difference during operation is ±5 bar If a general difference pressure of 1 bar is considered for the SSPP the maximum internal pressure will be −5+1=−4 bar. The tangential and radial stresses in the concrete rings base on −0.4 Mp differential pressure can be found as:

$${σ}_{i} = \frac{{P}_{i} {r}_{i}^{2} - {P}_{o} {r}_{o}^{2} - \frac{{r}_{i}^{2} {r}_{o}^{2} ( {p}_{o} - {p}_{i} )}{{r}^{2}}}{{r}_{o}^{i} - {r}_{i}^{2}}$$

$$( Shigley , Mischke et al . 2004 )$$

$${σ}_{r} = \frac{{P}_{i} {r}_{i}^{2} - {P}_{o} {r}_{o}^{2} + \frac{{r}_{i}^{2} {r}_{o}^{2} ( {p}_{o} - {p}_{i} )}{{r}^{2}}}{{r}_{o}^{2} - {r}_{i}^{2}}$$

$$( Shigley , Mischke et al . 2004 )$$

$$Where$$

$${σ}_{t} = SSPP Tangential Stress$$

$${σ}_{r} = SSPP Radial Stress$$

$${P}_{i} = Average Inside pressure ( 0 Mp )$$

$${P}_{o} = Average Outside Pressure ( - 0.4 Mp )$$

$${r}_{i} = Inside Radius ( 1.250 m )$$

$${r}_{o} = Outside Radius ( 1.519 m )$$

$${σ}_{concrete} = Max Concrete Ultimate Compressible Stress ( 300 kg \text{/} {cm}^{2} = 300 bar = 30 Mp for middle range straight concrete ( Jackson and Dhir 1996 ) . )$$

$${σ}_{i} = \frac{- 0.92 + ( \frac{0.76}{{r}^{2}} )}{0.74} -> r = 1.519 -> {σ}_{i max} = - 0.80 Mp tangential stress in external surface$$

$${σ}_{i} = \frac{- 0.92 + ( \frac{0.76}{{r}^{2}} )}{0.74} -> r = 1.25 -> {σ}_{i max} = - 0.59 Mp tangential stress in internal surface$$

$${σ}_{r} = \frac{- 0.92 - ( \frac{0.76}{{r}^{2}} )}{0.74} -> r = 1.519 -> {σ}_{r max} = - 1.69 Mp radial stress in external surface$$

$${σ}_{r} = \frac{- 0.92 - ( \frac{0.76}{{r}^{2}} )}{0.74} -> r = 1.25 -> {σ}_{r min} = - 1.90 Mp radial stress in internal surface$$

The results are much lower than the ultimate compressible strength of concrete (30 MP).

The cylindrical shape's buckling stress can be calculated with the following formula.

$${P}_{el} = \frac{2 {E ( \frac{t}{D} )}^{3}}{1 - {v}^{3}} ( Antaki 2003 ) Where$$

$${p}_{el} = Elastic Critical Pressure$$

$$E = The modulus of Elasticity ( 15 - 40 Gp for Concrete )$$

$$v = Poisson \text{’} s Ratio ( 0.1 - 0.3 for Concrete )$$

$$t = Pipe Wall Thickness ( 3.144 m )$$

$$D = Pipe External Diameter ( 0.322 m )$$

$${P}_{el} = \frac{2 \times 25 \times {10}^{3} \times {( \frac{0.322}{3.144} )}^{3}}{1 - 0.2} -> {P}_{el} = 56 Mp$$

And it is higher than maximum concrete ultimate compressible stress (30 Mp). This means that the pipe will fail before getting buckled.

1-4-6) Mooring Cable Design

The seafloor depth under the SSPP route is variable but the pipe should be submersible in a constant depth so the mooring system cables lengths are variable and must be chosen to match the pipe with the seafloor. It requires perfect seafloor topography to be able to find what the suitable cable length for each pipe element is. Longer cables are heavier and it makes the pipe unbalanced. To solve this problem the top ballasts' weight should be reduced for longer cables. It means that generally, the Submerge weight of top ballast plus the Submerge weight of its above cable should be the same along the whole pipe. The Cable should resist against the sum of ballasts' Submerge weights plus its Submerge weight so:

T_{Cable}=W_{CableWet}+W_{FBW}+W_{BBW}+W_{ChBW} Where

T_{Cable}=Cable tensile force

W_{CableWet}=Cable Submerge weight (The part of cable which is above the Top ballast)

W_{FBW}=Base ballast weight in water (Submerge weight)=21360 N

W_{BBW}=Top ballast weight in water (Submerge weight)=21360 N

W_{ChBW}=Chain Ballast weight in water (Submerge weight)=203670 N

For example if sea floor average depth is 2800 m and the pipe lowest operating depth is 2200 m, and cable weight in air per meter is 4 kg/m then:

$${W}_{CableWet} = ( 4 \times \frac{7850 - 1030}{7850} ) \times 300 \times 9.8 = 10220 N$$

T_{Cable}=10220+21360+203670+21360→T_{cable}=256610 N=26185 kg

And the cable diameter will be

$${σ}_{YCable} = \frac{{T}_{Cable}}{\frac{π {D}_{Cable}^{2}}{4}} Where$$

$${σ}_{YCable} = The Cable Material Yield Strength ( 600 Mp )$$

$${T}_{Cable} = Cable tensile force$$

$${D}_{Cable} = Cable Diameter So$$

$$600 \times {10}^{6} = \frac{256610}{\frac{π {D}_{Cable}^{2}}{4}} -> D = 23 mm$$

The cable diameter chosen here was 25 mm.

The cable tensile force is limited to the above value (256610 N). It means a stronger force can not be applied to the cable because if the cables tensile force exceeds the calculated force, then the base ballast will be lifted from the seafloor and after that there will be nothing to increase the tensile force and it will remain constant with the same value of 25661 N. In design of cables (wire ropes) usually high safety factors (can be between 3 to 12) (Shigley, Mischke et al. 2004) are used. These cables are one of the most expensive parts of the system and any little increase in their diameter can be very costly. Therefore, the mooring cables are designed with a low safety factor and are chosen to have a little higher strength than the maximum tensile force. These cables have low probability of failure due to the limited tensile force applied to them.

Corrosion should be fully considered for the cables. In practice cables repair is too difficult to do. It is essential to note that even few millimetres of corroded area can make hundreds of meters of cable useless. All the protection ways such as cathodic protection, water proof protection cover, change in cable material (using stainless steel or polymers), hot dip galvanizing, etc can be used for corrosion protection depends on their cost. Details of corrosion protection systems are not discussed here, simply because the corrosion protection methods are well-known, and appropriate protection technique can be relatively easily selected for these cables.

The arrangement of cables can be different from Y depending on the seafloor topography and where there is high velocity lateral current somewhere along the pipe route. In these new arrangement many concrete cylinders can be kept by one cable or they can be connected to the mooring system form their lateral sides. The new suggested cables arrangements are; bundle, bridge, and Centipede arrangement.

Bridge arrangement is exactly the mirror image of the cable arrangement used in suspension bridges. The cables which are connected to the concrete cylinders come done vertically and connect to a main parabolic cable which is kept from its both ends by the mooring system. FIG. 10.

In bundle arrangement the cables which are connected to the concrete cylinders will merge together and then will continue with a thick strong cable to the sea floor. FIG. 11.

The centipede cable arrangement can introduce to the pipe where there is a strong lateral current. In this arranging the pipe is kept from its both lateral sides. It means concrete cylinders are connected with two mooring systems which are on both sides of the pipe and there is a pair of ballasts for any pipe segment. FIG. 13.

The new option for centipede arrangement is that the buoys are used instead of the chain ballast. FIG. 12.

The centipede cable arrangement makes the pipe stable against lateral currents. This cable arranging can also include bundle or bridge arrangement. In this case the pipe will look like a huge centipede which is standing on the seafloor.

There are thousands of cables which are hanging from the pipe so it seams they can easily become entangled, but when the pipe is settled in the sea all the cables will move together, so no knotting can happen.

1-4-7) Earthquake and Seismic Activity

During massive tsunamis, it seems that oceanic seismic and volcanic activity could destroy the pipe. In this part the pipe behaviour due to these problems is briefly discussed.

If an earthquake makes a fault in sea floor, displacement waves will come up vertically through the water to release in the sea surface. In other words the waves choose the shortest way to reach the sea surface and don't distribute in whole water. These surface waves are broad and gentle in open seas and does not disturb deep waters. But as they approach the shore they will change and can damage the costal area. If the pipe has a proper distance with earthquake's epicentre it will not see the waves therefore the pipe route selection is an important design factor which can protect the pipe from seismic activity.

Earthquakes usually happen in tectonic plate boundaries and nowadays distribution of major earthquake and volcanoes are well known in the world so the pipe route selection can be chosen simply far from these hazardous areas to protect the pipe. Therefore, the pipe is generally not designed for earthquake but as a special case it can be considered what the pipe behaviour would be during an earthquake.

Earthquakes themselves are very complex and their effects on such a submersible pipe in the ocean is a complicated subject. Therefore here the subject is simplified as much as possible. If a single rigid body object like a submarine, submersible in water, has full degree of freedom (not isolated) and due to earthquake waves, moves so no internal force applies to its structure. In this case a couple can also turn the rigid body. However, it does not seem that an earthquake can create a couple in sea water so this is not considered here.

If the SSPP is considered in the same point of view it is just isolated in its longitudinal direction. Thus, only longitudinal forces on SSPP due to an earthquake should be considered. Other stresses will not affect the pipe simply because the pipe is free to move and behaves like a free object.

With a brief review of earthquake basics, there are two types of body waves (P and S) and also two type of surface waves (Rayleigh and Love).

(Skinner, Porter et al. 2003)

When a P wave passes over the pipe, it will move and deform a little temporarily. The model that can explain this case is a long spring with a rigid or a stronger spring in the middle. The passing of a P wave over the pipe makes a compression force in the pipe for a very short time so it does not damage the pipe.

S waves can not touch the pipe because it dose not pass through liquids. If the earthquake epicentre is located in the pipe route, the waves will shake the seafloor. Love wave makes shear between water and seafloor so for the same reason as in the S wave case it never reaches the pipe.

Rayleigh waves can displace the water above the seafloor vertically. This displacement goes to the sea surface and will shake the pipe but the movement will be along its free axis so it will move experiencing no internal force.

Above discussions show that the pipe is safe against ocean's earthquake. However, problems arise when the seafloor is fractured. In this case if SSPP is above the fault and is perpendicular to the fault direction, at the time of fracture, huge columns of water which are above the fault move vertically. The pipe's part which is in the column will move while the other parts remain stationary. Therefore the pipe is stretched and bent above the fault. The tensile force in the pipe can be a function of the fault displacement, velocity, and acceleration of fracture. It is also a function of the pipe's longitudinal flexibility, weight and diameter. The pipe behaviour under these conditions is beyond the scope of this study, but since it is a very special case, the pipe feasibility can be accepted and this point can be considered for future work.

1-5 SSPP General Notifications

SSPP description constitutes different topics which are hardly related together. The following is a collection of these descriptions in order to clarify the basic concepts behind each topic.

1-5-1) Gas Composition

The gas composition is an important issue in SSPP operation. The pipe is designed for the most common gas composition (standard gas). If the gas that is being transferred has a significantly different composition than the standard gas, it will change the pipe settings because the new gas density does not match with the chain ballast weight and the ballast may not be able to equalise the internal and external pressure properly. It is preferred that the transported gas to have a high percentage of ethane to minimise condensation in the pipe. The pipe is running in very high pressure (250 bars) and temperature (˜2° C.). Under this condition the high mole fraction (>%10) of heavier component (>C₂) can change the gas to liquid form.

1-5-2) Gas Pressure in the Pipe

Gas density in many cases can be neglected, but in SSPP gas has high pressure and density and, therefore, the gas hydrostatic pressure should be considered in pressure calculation.

The gas dynamic pressure can be neglected in SSPP because it has large diameter and the gas passes through it slowly. The SSPP is completely horizontal when there is no flow and the pipe just statically pressurised with gas. If the gas flows, the pipe will find a slight slope because the gas pressure drops as it passes through the pipe. The pipe downstream which has a lower pressure will escalate to equalize the external and internal pressure and it makes a slope along the pipe. Therefore, it is essential to consider the pressure drop along the pipe In order to deliver the gas at right pressure, downstream. The downstream pressure is equal to upstream pressure minus the sum of predicted pressure drops and hydrostatic pressure changes. P₂=P₁−(ΔP_{Flow}+ΔP_{Hydrostatic})

1-5-3) Pipe Failure

The third party damage, corrosion and corrosion induced cracking are the most important causes for the pipelines failure (Hopkins 2005). However, they are not big issues in SSPP because the pipe environment is far from the human activities, the pipe dose not carries corrosive materials, and cracks do not grow in SSPP walls because it is stress released. However, in case of a failure, it is equipped with a system that separates the damaged piece to protect the pipe. This system is explained later in the primary stations section. A spare pipe segments (100 km) can be stored in a costal area while it is ready to install. If a pipe segment failed the spare segment will be carried and installed in place of the failed segment.

1-5-4) Leakage in the Pipe

In case of a leak it is preferable for the gas to leak out rather than the water leaking into the pipe because liquids in the pipe can make it unbalance. For this reason the pipe's internal (gas) pressure is controlled so that it is higher (a little) than its external (hydrostatic) pressure under the normal conditions. However SSPP can be in a condition with higher hydrostatic pressure therefore it has a leakage system which can collect the leaking water from the pipe and send it back to the environment. This system is explained later in the primary station section.

The difference between the external and internal pressure is very low (0.0 to 1.2 bar) because high differential pressure increases the leakage rate. The pressure difference is selected base on SSPP vertical displacements in normal conditions. This means that while a maximum operating current (0.1 m/s) is passing over the pipe, due to pipe movement the internal pressure remains higher than the external pressure.

TABLE 1-4

| | Average | Average | |
|---|---|---|---|
| | Internal | External | Differential |
| | Pressure | Pressure | Pressure, ΔP |
| | bar (psi) | bar (psi) | bar (psi) |
| Normal condition: Very low | 225 | 224.4 | 0.6 ≦ 0 |
| velocity or horizontal currents. | (3285) | (3276) | (9) |
| Normal condition: Downward | 225 | 225 | 0 ≦ 0 |
| current (max velocity = 0.1 m/s) | (3285) | (3285) | 0 |
| Normal condition: Upward | 225 | 223.8 | 1.2 ≦ 0 |
| current (max velocity = −0.1 m/s) | (3285) | (3267) | (18) |

1-5-5) Vortex Induced Vibration

Subsea pipelines must be checked for vortex-induced vibration but for SSPP this consideration is different. The current velocity which is passes over the pipe may vary between 0 and 0.3 m/s so the Reynolds number can change from 0 to 8.5×10⁵. Thus, all types of flow patterns (Steady separation, Karman vortex, wide turbulent, narrow turbulent) can happen with wide range of frequency.

SSPP has 6 degrees of vibration so it is difficult to find its natural frequency modes. The pipe oscillates like a pendulous so if its depth is changed, its natural frequency will be changed too. Therefore, SSPP can have a wide range of natural frequency.

If to the SSPP is classified based on DNV code its L/D ratio is more than 250 (it is infinity indeed). Therefore, it will behave like cables (DNV 2000). However, it is not hanging like a cable from two fixed points so its dynamic behaviour is too complicated. Considering the above explanations, it is difficult to say the resonance can occur or not, although SSPP is flexible and can move freely. Therefore, when the pipe is oscillated there is no fixed point (like the offshore anchoring point) that the cyclic loads and stresses concentrate on it and create a fatigue failure. Thus the pipe will oscillate when a flow passes over it but this vibration does not case a problem.

1-5-6) SSPP Connection to Offshore Stations

The offshore stations can be assumed as fixed points in the system so the pipe must be more flexible and also have a higher strength than the other part. SSPP has two end Y branches which connect the pipe to the stations. The Y branches are sited on the stations and are fixed to them so they are not free to move with the pipe. The Y branches have a flexible part which can bend properly and connect the pipe to the stations.

1-5-7) Passing over Sea Ridges and Trenches

Oceans' topography shows that in the most marine distances a suitable depth about 2000-3000 meters can be found for the SSPP rout selection. In special cases it may be needed to pass over the seafloor's ridges or trenches and it is not preferred to change the whole pipe level just for passing over theses areas.

If the SSPP should be passed over a narrow ridge, the best choice is that some normal steel pipelines are led on the ridge and the SSPP is connected to them to be passed over the ridge.

If the SSPP reaches a narrow deep trench, its cable arrangement must be changed to be able to pass over a deep trench.

1-5-8) Life in Deep Water

Life in deep water should also be thoroughly considered. Life in depth about 2000 meter is very limited and there is no large animals live in this depth. Therefore the pipe will not be damaged by the animals directly. (Pinet 2000). If small animals, plants or bacteria stick to the pipe they can change the pipe density and make it imbalanced. However, the sea creatures have close density with sea water so small colony of them on the pipe can be neglected. The animals usually have tails in this depth and it means the want to move so they will not stick to the pipe. (Pinet 2000). The Chemosynthetic Communities (plant and bacteria) like mussels and tube worms may be seen on the pipe especially if there is a gas leakage somewhere because they can use methane as source of energy for living. (Pinet 2000). Special chemicals are used in the ships painting which stops the bacteria growing. The same material can be used on SSPP surface to control the bacteria's activities.

1-5-9) SSPP Other Parts

SSPP has some secondary parts such as internal and external railways, electricity cables, internal pipes which are explained in other chapters.

1-6 Chapter I References

Antaki, G. A. (2003). Piping and Pipeline Engineering Design, Construction, Maintenance Integrity, and Repair. New York, Marcel Dekker.

Couper, A. (1989). The Times Atlas and Encyclopaedia of the Sea. London, Times Books.

DNV (2000). “Free Spanning Pipelines.” DNV Standard Guideline No 14.

Duxbury, A. C., A. B. Duxbury, et al. (2000). An Introduction to the World's Oceans, McGraw Hill.

Energy Administration. (April 2004). International Energy Outlook 2004. Washington, D.C., Office of Integrated Analysis and Forecasting U.S. Department of Energy.

Hopkins, P. (2005). Fundamental of Pipe Line Engineering.

HYSYS (2002). HYSYS 3.0.1, Hyprotech LTD.

Jackson, N. and R. K. Dhir (1996). Civil Engineering Materials. Basingstoke, Macmillan.

Meriam, J. L. and L. G. Kraige (2002). Engineering Mechanics Statics. New York, J. Wiley.

Mohitpour, M., H. Golshan, et al. (2003). Pipeline Design & Construction. New York, ASME Press.

Orcaflex Version 9.1 Orcina Limited

Pinet, P. R. (2000). Invitation to Oceanography. Sudbury, Mass, Jones and Bartlett.

Shigley, J., C. Mischke, et al. (2004). Mechanical Engineering Design. London, McGraw-Hill.

Skinner, B. J., S. C. Porter, et al. (2003). Dynamic Earth An Introduction to Physical Geology. Chichester, Wiley.

Sonntag, R. E., C. Borgnakke, et al. (1998). Fundamentals of Thermodynamics. New York, J.Wiley.

White, F. M. (2003). Fluid Mechanics. Dubuque, Lowa, McGraw-Hill.

Chapter II

GSTS Components

2-1 Introduction

The transmission system (GSTS) is made from different parts with different functions that are matched together. In chapter one, the Submersible Suspension Pressure-equaliser Pipe (SSPP) is introduced as the main part of GSTS but the system needs more components to be able to transfer the gas through the oceans.

This chapter describes the GSTS' secondary components, their function, new systems and devices.

GSTS's secondary components are: Offshore stations, Primary stations, Linking stations and Branch lines which are explained in this chapter in order.

These components may be completely new devices or may be exactly the same as the equipment that have been used in the industry. Therefore, the design, construction, installation and operation methods for devices that are currently used are not undertaken.

2-2 GSTS Offshore Stations

Stations are important parts of a pipeline. They are access ways for operating, getting information and inspection of pipelines, therefore GSTS like any other pipeline needs stations to be separated in smaller segments and be controlled by them. GSTS stations are functionally similar to the pipelines' onshore stations, but they should be able to function in the middle of oceans and in deep waters. GSTS stations are also used for the pipe installation so in contrast to onshore pipelines they must be installed first, before SSPP segments. It is difficult to find the right distance between GSTS stations. It needs a comprehensive risk and economical analyses based on experimental data which are currently unavailable for GSTS. The distance is chosen as 100 km (60 miles) here is based on the SSPP construction and installation issues however it can be reduced as needed. The following is a brief comparison to clarify the differences and similarities of GSTS stations and common offshore platforms
a. GSTS stations are much smaller in dimension and weight than offshore platforms.
b. GSTS stations are special valve stations so their activities are much simpler than offshore platforms. Therefore, the stations can be controlled from the shore in normal operation without permanent offshore crew.
c. GSTS stations are too small to be stable against adverse conditions so they are not fixed and are submerged for protection.

GSTS offshore stations have four main parts: command module, operating module, floating module, and mooring system which are described one by one as follow. FIG. 14 & FIG. 15.

2-2-1) Offshore Station Command Module

The offshore station's command module is the only part which is accessible to people, therefore, all the installation, operating and maintenance activities are led from this section. Command module is designed as submersible. This feature protects it from the ocean's stormy conditions. It also helps to achieve lighter structure and mooring system. Command module is submerged in shallow waters (depth about 100 meters) to be accessible for divers. In this depth the waves' hydro dynamic forces are decreased rapidly. Command module is able to float on sea surface in calm condition for accessing, installation or maintenance progress but it is submersible while the pipe is normally operated.

The station's command module parts from bottom to top are: two pontoons, external open workshop, central sphere, helipad and a strong structure which connects these parts together. They are explained in the following pages.

Command module geometry is pyramidal. Central sphere located at the apex of the pyramid, the main columns are lateral edges and pontoons form the sides of the square base. FIG. 16, FIG. 17 & FIG. 18.

2-2-1-1) Pontoons

Station's pontoons are two cylindrical vessels which are parallel with the pipe. They are used as ballast tanks to float and descend the command module. When they are full of water, the station's buoyant force is almost cancelled out with its weight and it can be submerged by pulling the mooring cable. When the command module is settled on surface or under the water the pontoons are filled by air to raise the buoyant force and pull the mooring cable harder. This makes the command module stable in its place. While command module is floated, the pontoons are submersible to decrease the wave-attack area and have fewer tremors on the station; however, pontoons can be floated if needed. Pontoons are also tanks for fuel and chemicals (inhibitors, anti foam, etc). While the chemicals are being consumed water must be replaced to keep the buoyant force almost constant. Therefore, these tanks have a special sealing that separates the fed water from the chemicals in the tank.

2-2-1-2) External Open Workshop

The installation and maintenance activities need a specific area. This area is prepared in the command module's open external workshop. It is a rectangular area between central sphere and pontoons. The workshop height from sea surface is adjustable but it is usually close to the water while the station is floating. The workshop's floor has a structure which is covered by grated plates (using grated plates will decrease the waves and currents forces). The floor has a longitudinal gate which is opened to take the equipments in or send them out of the workshop. The gate is opened and closed by powerful hydraulic jacks. Overhead cranes cover the workshop area and winches are available to pull the Pipes' head (Y branch) and take them into the workshop for connection process. The workshop is equipped with large wheels that the Y branch can be sat on them and be slid into the workshop. After the two pipe segments are jointed together the floor's gate is opened and the pipe is sent to the water.

2-2-1-3) Central Sphere:

Central sphere is GSTS's brain. It is a hallow sphere like LPG sphere tanks but it is under the external pressure the same as submarines. The pipe crew can stay in it to do their commissions while it is submerged. Central sphere must be designed to resist the hydrostatic external pressure in a depth of about 100 m properly and safely. For this reason it has an internal structure to increase its strength against external pressure. It is predicted that the central sphere has a diameter between 10 to 15 meters. The sphere includes: entrances, control room, engine room, accommodation area and workshop-lab which are explained as follows.

2-2-1-3-1) Entrances

Central sphere has two main entrances; one on the top and the other at its bottom. The top one is for human access. It is small and can open and close manually, it has two doors and an entrance room at the middle and it can be used in both wet and dry conditions. It is similar to a submarine entrance. In normal operation the command module is floated on sea surface (dry condition) and then people may enter it. However, in special case that the command module can not be floated (wet condition) a diver may enter by following these instructions: opening the first door, going to the entrance room, closing the first door, gently depressurising the room, opening the second door and finally enter to central sphere. The bottom entrance is an access to the external workshop and also a way for taking the instruments and facilities in or out of the central sphere. It is a big flange shape door and can be used only in dry conditions. The bottom entrance can have a manhole which is used for personnel access.

2-2-1-3-2) Engine Room

Power Generator, air conditioning system, nitrogen maker package, water treatment package, parts of flaring system and the other mechanical devices such as pumps, compressors, electro motors, valves, control valves, etc which are used for the system operation are installed in the engine room.

Power Generator:

The GSTS required power is supplied by the station's power generator. Each station has a generator which can be powered by an internal combustion engine or turbine. The runner must be able to work with both gas and liquid fuel. It is fed by the pipe's gas during the normal operation but in installation phase and emergency cases it consumes petrol or diesel. The generator capacity is chosen based on the station's gas compressor as the most generated power in the station is consumed by the compressor. The generators electricity are connected and matched together (voltage, frequency etc) by the pipe's internal cables to provide an integrated source of electricity. If one station's generator shuts down, it can be supported by the neighbour stations.

Submarine System:

The command module is floated or submerged by changing its buoyancy force. This mechanism is called here as submarine system because it functions the same as submarines. Submarine system has pumps, compressors, valves, etc which are all in engine room. Submarine system tanks are in the pontoons and can be filled or emptied from engine room by the connection pipes. The station's systems are usually not working simultaneously, due to the limitation area in engine room. Therefore, the machineries such as pumps, compressors, etc are designed to be able to be used for different purposes.

Water Treatment Package:

The water which is gathered from the pipe and pumped to the command module is polluted. It is mixed with hydrocarbons condensate and chemicals (inhibitors etc), so it is not possible to send it back to the seawater. The inhibitors and chemicals which are sprayed to the pipe are expensive material therefore they must be separated and renewed. The main duty of the water treatment package is to cover the above issues and it is also able to prepare the drinking water for station's crew from seawater. This system can also help to protect the command module external facilities such as cranes, winches, lifeboat, etc from corrosion and sea creations. These facilities can be separated from the sea water by a sealing cover which is filled with pure water and anti corrosion chemicals and the treatment package.

Air Conditioning System:

Central sphere must be well ventilated. The station's air conditioning system prepares suitable fresh air for personnel in central sphere. It has some risers which are connected to the floating module and can bring fresh air from sea surface to the sphere. These risers are flexible pipes which can resist the water external pressure. The system can also send stale air and gases (exhaust gas) from the central sphere to the atmosphere by another flexible riser.

Nitrogen Extractor Package:

GSTS, like other oil and gas plants, must be able to purge the gas with nitrogen to avoid fire or exploration. Nitrogen extractor package is a small system which prepares the required nitrogen for the pipe installation, operation and maintenance.

2-2-1-3-3) Workshop and Lab

There is an area in the central sphere to do overhaul and maintenance activities, store some primary tools and spare parts and also it can include a lab for tools calibration, inspection etc. Overhead cranes will cover all the engine room and the workshop area and they are available to move things anywhere inside the central sphere and also send them out or bring them into the central sphere.

2-2-1-3-4) Control Room and Controlling System

GSTS Offshore Stations control room is the same as other control rooms in industries. It has the required area for control systems and the people who work with them. The controlling system is able to be controlled from outside (the coastal offices) as well. SCADA is a good candidate for the controlling system; it can send the information stations to stations or using satellite to make a control network. Detailed specification of the control system is not mentioned in here however its availability and duties can be explained as follows.

The control system must sense, transfer, receive, record, dispatch, and analyze data, such as outside and inside pressure, flow rate, temperature, elevation, gas composition and be able to perform the suitable commands. It should be able to find the pipe profile and movement and also mooring system reaction. It can do it by using a radar system which sends signals between two stations. This radar system can also report any ship or other activity in the surrounding area. Warning messages can be sent to them should they be in hazardous area. It must also report the weather, sea surface and under water conditions and must be able to sense currents' velocity, leakage and failure. The control system orders to all GSTS instrument and equipment and. All systems and packages such as control valves, power generators, pumps, compressors, winches, cranes, internal and external pigs, inside and outside lights and cameras, etc will be managed by GSTS control system from the central sphere's control room.

2-2-1-3-5) Accommodation Area

All necessities for housing a few people in the station should be considered in the accommodation area. The crew commissioning in the stations can be present for long time (few weeks) in the installation phase and it will probably be shorter (few days) in operating and maintenance periods. In special cases, the station may remain submerged for weeks without any access to surface. The accommodation area must have enough amenities and supplies to maintain the crew during this period of time.

2-2-1-4) Structure

The command module's main parts are connected by a strong structure. It is also a support for external equipment such as, pipes, winches, cranes, hydraulic jacks, lights and cameras etc . . . , which are installed on it. The structure columns are the pyramid's lateral edges and they are not vertical. Therefore, due to the lateral forces they want to keep distance from each other. In the pipe direction the pontoons fix the columns bottom and in the direction perpendicular to the pipe, there are two reconnect able beams which keep the columns bottom. Also in this direction trusses are designed for the structure to increase the column straight against lateral displacement.

All structure elements (beams and columns) have circular cross section to drop the oceans wave and currents' forces. Station's structure has ladders, platforms, stairs and hand rails to make the whole command module accessible safely. Station's structure holds two lifeboats above the pontoons to be used in emergency case.

2-2-1-5) Helipad

Helicopter can be a good vehicle for fast access to the stations so a small helipad is considered above the central sphere. Due to the station movements the helipad must have a locking system to keep the Helicopter fixed on its surface.

2-2-2) Offshore Station Operating Module

The pipe physical operation is done by the station's operating module. It is the section which is in touch with the pipe and can operate it with the equipments that can be controlled from the command module. Operating module is located between two SSPP segments and it connects the segment's Y branches together. Operating module has three main parts: a casing which is a house in deep water for the other parts sitting and settlement, a pair of middle cylinders which are short pipes that includes the section's equipments and machinery and two pairs of controllable block valves which can block the pipe. A pair of operating facility is considered for this section. When one set is out of order the spare one runs the pipe while the repairing is in progress. The pipes' end Y branches are sat on the casing in a way that their branches are located face to face. A set of middle cylinder and two block valves at its end connects each branch to the opposite one. Operating module parts must be able to be taken up for maintenance so they must have special separable connection joints which can function in deep water. Operating module is designed to have no weight under its normal operation. In the other words, its weight is cancelled out by its buoyant force.

Operating module can move over the station mooring cables to equalise the pressures. It moves mechanically like a lift and does not have the chain ballast mechanism. It is locked in the proper depth so it is not influenced by the currents and can keep the pressures equal, perfectly. FIG. 20, FIG. 21 & FIG. 22.

2-2-2-1) Middle Cylinder

Operating module has a pair of middle cylinders. They are short length pipes (about 12 meter) with the same diameter as SSPP (100″-2.5 m). These parts can move between the station command and operating modules easily. Therefore, most of machineries, equipments and instruments are insulted in theses parts to be easily accessible for checking and repair.

Middle cylinder is the system's central connection point. It connects the SSPP segments, the command module, the operating module and in some case the branches (supplying or consuming) together. Middle cylinder is an important part in the system. It is introduced here by describing its main parts which are risers, equipments and Branches. FIG. 20, FIG. 21 & FIG. 22.

2-2-2-1-1) Middle Cylinder Riser

Since a station has a pair of middle cylinders it has a pair of risers too. The risers are a collection of lines and cables. They include many lines (feeding, liquid and gas lines) and cables (instrument and power cables) which connect the cylinder to the control and the engine rooms. The risers are flexible and can move with the middle cylinder. They are located in both sides of the pipe. FIG. 15 No 12.

The riser has a U-shape which is hanged from its both ends from the central sphere and the middle cylinder. When the middle cylinder is in command module, the U-shaped legs have the same length but when it is in operating module the external leg is much longer than the other.

Feeding Line:

Feeding line is the largest line (Diameter around 4″-6″) in the riser and it transfers high pressure gas between the middle cylinder and central sphere. This line is used in installation and operation phases and can be made from the reinforced thermoplastics pipes. When a new pipe segment is being installed, one of the middle cylinders is connected to an installed segment in the operating module and the other one is connected to the new segment in the command module. The exit gas in the installed pipe is sent to the engine room by one of the feeding lines to be pressurised and then be sent to the new segment through the other feeding line. While the new SSPP segment is being filled with the gas, it sinks and takes down the middle cylinder and the feeding line. In operation phase the feeding line sends the gas to the engine room for the generator consumption. It can also be used to fill the pipe or middle cylinder with Nitrogen or air.

Liquid and Gas Line:

Theses lines are used to transfer liquids and low pressure gas. They are also parts of the flaring system so they are explained in the GSTS station systems section.

Power and Instrument Cable:

The power cable transfers the required electricity from the command module to the operating module. This electricity is also distributed between other offshore stations from the middle cylinder through the SSPP. The instrument cable transfers all commands and reports between the control room and the operating module's equipments and instrumentations.

2-2-2-1-2) Middle Cylinder Equipments

Middle cylinder equipments can be categorised as follow.

Gas Compressor:

Middle cylinders have rotary compressors which pressurise the gas to 0.4 bar (6 psi). These compressors are much simpler than the onshore pipeline's compressors. They pressurise the gas in one stage and they do not have any particular cooling system. These compressors are strong fans with a powerful (2 MW) electromotor. The operating module has just one compressor because if it is failed the neighbour operating modules can cover the pressure drop during the repair. Therefore, one of the middle cylinders includes the compressor and the other one is used as a bypass.

High Pressure Pump:

This pump is a reciprocating type with low flow rate and very high output head. It is actually part of the flaring system. It can be used to fill or drain the liquids from the middle cylinder and also it can be used to spray the inhibitors into the pipe.

Control Valves and Connections:

All flow lines are connected to middle cylinder by the control valves therefore the middle cylinder inputs and outputs are controllable. Middle cylinder is able to send out or take in the gases (natural gas, nitrogen, air) and liquids (water, condensates, inhibitors) to the other parts (the pipe, command module, flaring system, etc) and the environment.

Controlling and Electrical Devises:

Middle cylinder has many sensors and controlling devices. It can sense internal and external pressure, gas flow rate, internal and external temperature, elevation, gas composition, outside current's velocity, the pipe tensile force and leakage. All the contactors, control switches and electrical devices which are used in the pipe operation are installed in the middle cylinder to be accessible for repair. The middle cylinders should distribute the power to the whole system so the transformers, which raise the voltage, operate with minimum energy loss.

Branches:

All branches (consuming, feeding) and bypasses are connected to the pipe from the middle cylinder. These connections are similar to the SSPP connections. It means they have block valves and specific areas to be sat in the casing. All middle cylinders have equal T's for bypass connection and some of them, depending on their locations, have consuming or feeding connections. The branches' connections are usually blocked by blind flanges but it is simply possible to take the flange out and install a new junction.

2-2-2-2) Controllable Block Valves

Operating module generally has four valves (two in each line) which are located between Y branches and middle cylinders. They are big and must be fully bored so the best type of valve which can be chosen for them is the gate valve. These valves have not been used in oil and gas industry but they are regularly used in the water industry, especially in dams or in hydroelectric power stations. These valves are on-off valves and they are not used to control gas flow in the pipe.

FIG. 24

These valves are different from other valves because, firstly, they are not under the pressure and secondly, their environment is not atmospheric. These two important characteristics make them feasible to be used in offshore stations. Same external and internal pressures make their body lighter and simpler and also help them to seal properly and easily. Their surrounding pressure let them have a special connecting mechanism which can not be used in the other valves. This mechanism is called here Magnetic-Vacuum connection. Due to maintenance requirements, the valves must be able to connect and disconnect to the middle cylinder and Y branches frequently and easily. Block valves, middle cylinders and Y branches have specific flanges at their ends to be connected. Theses flanges have a circular groove on their surface which is surrounded by O rings.

FIG. 25

Block valves have powerful electrical magnets which can magnetize the flanges. They also have a suction system (pump, control valves, etc) which is connected to the flange's groove. FIG. 24 & 25.

When the valves and the middle cylinders or the Y branches are sat on their right positions, their flanges are located face to face. In this position the valve's flanges are magnetized to attract and stick to the flange of the middle cylinder or the Y branch (there are some guides on flanges to lead them to mach together properly). Then the pump sucks and pulls out the water that is remained in the groove. When the groove is emptied the hydrostatic pressure pushes the flanges hard and makes them seal. Then, the flange magnetization is stopped till another connecting process. If the vacuuming system fails the flanges are magnetized temporarily to be kept connected till the joint is sent for the repair.

The O rings may need to be changed after the separation process so they are always installed on the part which is supposed to be sent up for repairing. It means between the valves and the middle cylinders, the O rings are installed on the middle cylinder flanges and between the valves and the Y branches they are sat on the valve flanges. The vacuuming system is an elegant system so it is suggested that the valves have a pair of these systems to be able to save one as spare.

In the separation process the vacuumed area must be filled with water. It is possible that the system control valve fails and it can not release the vacuumed area. In this case the flanges are not separable. There is a sealed needle on the top of the valve's flange which is crammed into a hole that connects to flange's groove. The problem can be solved by pulling this needle out. FIGS. 24 & 26.

The block valve has a hydraulic jack which opens and closes the gate. The valve hydraulic servomotor system includes pump, valves, hydraulic connections, electric panel, etc.

They are water resistant and are installed on the valve casing but they are controlled from the control room. The valves connecting and sealing surface (flanges surface, the gates edges) must be made from corrosion resistance stainless steels.

The SSPP internal lines (explained in the primary stations), must be connected to the middle cylinders. Therefore, the valve's gate and casing have some holes which are connected to the internal lines to pass their flows. When the gate is close, it also closes these lines and when it is open its holes situate face to face with the casing holes and let the flow pass through the valves. The valve must be sealed well around these points because the lines are run in different pressure. These lines may need to be closed in normal operation so the gate can be moved a little to close the lines while the SSPP is open.

FIG. 24 & 26

Gas leakage from the flanges during the connecting process can create hydrates. The hydrate crystals on the flanges surface can make a problem for a proper sealing so the valve has a heating system to remove the probable hydrate around the flanges. The middle cylinders, particularly the one with a compressor, can have their own valves and are not to be filled by seawater when they are carried between the command module and operating modules. This means that the operating module can have six or eight block valves. The added valves are the same as the controllable valves but they are dedicated to the middle cylinder and they don't have the connecting mechanism.

2-2-3) Offshore Station Floating Module

Offshore station must be in touch with the sea surface and atmosphere so the floating module is introduced to cover this necessity. It is a small sphere (diameter around one to two meters) with a little derrick on its top and a little weight at its bottom, and is connected to the command module by a rope. The weight which is connected to the sphere bottom makes it possible for the floating module balance and keeps the derrick vertically on its top. Floating module is almost always floated and it is designed to resist against stormy conditions. However, it can be submerged for a short time in unpredicted conditions (command module can pull it down by a winch). There is a supported ring beside the helipad which the floating module can be sat on it while the command module is floating. It is equipped with instruments to sense the sea surface and atmospheric conditions and report it to the central sphere (a camera can be added for viewing). It also has an alarming light on its highest point to show the hazardous area.

Since the dispatching (telecommunication) is much easier through air than water, the control systems' transmitter and receiver are installed in flouting module to provide a suitable communication between the stations and the shore. Both ventilation lines' head and flaring system's tips are located on the floating module therefore; they should be designed in such a way that these gases are not introduced into fresh air line. FIG. 19.

2-2-4) Offshore Station Systems

Mooring, monitoring, blocking and flaring systems are the stations independent systems which are explained as follow.

2-2-4-1) Mooring System

GSTS Offshore Stations are not massive like the offshore platforms so they are fluctuated and displaced simply by the sea waves and currents. They need strong mooring system to make them stable in oceans. The mooring system includes two parts: The lateral mooring and the central mooring. FIG. 14 & FIG. 15.

2-2-4-1-1) Lateral Mooring

The station's mooring system is a square pyramid. The square base's sides are parallel or perpendicular with the pipe and four anchor weights are sited on its apex. The command module is located at the pyramid's apex and is connected to the weighs by strong cables. The cables made the pyramid's lateral edge. Lateral mooring system stabilises the command module in both lateral and vertical directions. It especially fixes the command module while it is being floated for accessing, installation, or repair.

2-2-4-1-2) Central Mooring

The central mooring is the pyramid's height. It is the station main column which the command and operating modules are settled on it. This mooring stabilises the command and operating modules in the vertical direction. The central mooring has four strong cables which are stretched between the command module and an anchor weight which is at the centre of the pyramid's square base. These cables are rails for a special lift which connects the command and operating modules. The lift can carry the operating module's components to the sea floor for checking and repair. The lift can move based on the changes in its buoyancy force or can be pulled with a long cable by a winch or can have both mechanisms.

2-2-4-1-3) Mooring System Function

The mooring cables tensile force is dictated by the command module buoyant force. Therefore, if the station buoyant force changes, so will the cables tensile force. The command module is designed to have almost equal (a little lower) density to water when its tanks are fully filled with water. So if it is released from the cables it will always float on the sea surface.

The command module submerging has a specific process which is explained as follow. First the command module is fully filled with water (it has small buoyant force). Then the winches pull it down to the proper depth after it is locked to the cables. Finally, the command module is filled with air to increase the buoyant force and stretch the cables with the required tensile force. The same process can be done when it is desired to send the command module up.

From the above explanation it can be found that the winches must have a strong locking system. However, they do not need a powerful rotary system to pull the cables. The winches can work by a hydraulic mechanism which its driver pump is installed in the engine room. Depending on the station's conditions, the total tensile force can be divided between the central and the lateral cables by the winches locking system. For example, when the station is floated in a wavy condition the lateral cables must be pulled strongly but when the lift is moving, the central cables must be stretched hard. FIG. 14-FIG. 15.

2-2-4-2) Movable Block Valve System

In some cases the pipe must be temporarily blocked; for example, when it is required to send the controllable block valves up. Movable Block Valve System is a vehicle which can move inside the pipe and can be controlled from the control room. It has a source of energy independent of the pipe. This vehicle has a compressor and two balloons. When it is introduced to the pipe from the middle cylinder it moves and passes the control valve and enters the Y branch. It then inflates its balloon with gas by the compressor and blocks the branch temporarily so the control valve can be released for repairing. If the controllable valve breaks down in close position the machine is introduced from the other middle cylinder goes in to the Y branch, turns and comes behind of the damaged valve and block the pipe. After the valve is repaired, it releases the gas from the balloon and be sent up to be used again. FIG. 27.

2-2-4-3) Monitoring System

The most activities in GSTS installation and operation will be done in dark deep water without any human presence, so the monitoring system functions as the operators' eyes. Cameras and lights are kept in the stations and all of them can be carried to surface for maintenance. Today, technology has introduced the deep water cameras and lights which can work at high pressures in deep waters.

2-2-4-4) Flaring System

Almost all the oil and gas plants have a flaring system for safety. In some of small onshore gas pipeline stations there is no flaring system and gas blows to the atmosphere directly. But methane is a strong green house gas and venting it to the atmosphere is not desirable. Therefore, a flaring system is considered in the GSTS offshore stations to be able to burn all the useless gases.

The flaring system components are distributed in the whole offshore station. It includes a set of equipments between floating and command modules (upper equipments) and a pair of equipments between command and operating modules (lower equipments). The lower equipments are installed in the middle cylinder and are moved with it. The flaring system components from bottom to top are: two-phase separators, high pressure pumps, lower gas risers, liquid lines, gas burner, liquid tank and upper gas riser. FIG. 23.

2-2-4-4-1) Two Phase Separators

Two phase separators are vessel beside the middle cylinder which all useless liquids and gases are sent there to be separated. It has low internal pressure (almost atmospheric) but it is a high pressure vessel in order to able to resist the high external pressure. The vessel is connected to the lower gas riser, the middle cylinder and the leakage system suction line from the top and is connected to the high pressure pump and middle cylinder from the bottom. The pumping system controls the liquid level in the separator.

2-2-4-4-2) High Pressure Pumps

Gases go up from the separator due to the difference of pressure but liquids should be pumped to the command modules. The high pressure pump must have 2000 meter outlet head so it is a special reciprocating pump. However, it does not need to be a very powerful pump because its flow rate is very low.

2-2-4-4-3) Lower Gas Risers

The lower gas riser is a flexible pipe in the middle cylinder's riser which connects the two phase separators (in the operating module) and the gas burner (in the command module) together. This line should resist against the high external pressure (specially buckling). Today's flexible pipes (RTP) are suitable candidates for this purpose. The structure of these pipes can be changed for this particular usage (stronger inner carcass, weaker cross wound tensile armours and no zeta interlocked spiral). If the line fails the check and control valves, its ends will be closed to protect the vessels from the sea water.

2-2-4-4-4) Liquid Lines

The liquid line connects the high pressure pump (in the operating module) to the liquid tank (in the command module). It must be flexible but does not need a strong structure because internal and external pressures are in equilibrium. The liquid hoses are good suggestions for this line.

2-2-4-4-5) Gas Burner

It is a vessel in the engine room which burns the waste gases. The central sphere unpleasant air and the generator exhaust are also sent to this vessel.

2-2-4-4-6) Liquid Tank

The pumped liquids are gathered in the engine room's liquid tank. The gas is separated from the mixture and is sent to gas burner and the liquids are transferred to the water treatment package.

2-2-4-4-7) Upper Gas Riser

Upper gas riser is located between gas burner and the floating module. It sends exhausts gases out from the system. It is a flexible pipe like the lower gas riser but due to the gas flow rate and velocity its diameter is bigger than the lower riser.

2-3 Primary Stations

Perhaps “station” is not a proper name for these parts, but they somehow look like small stations so they are called “Primary Stations” in here. Primary stations are tube shape steel parts which separate a pipe segment (100 km) to the shorter parts (primary segment). Their interval distances can be about 1000 meters (see installation usage) and they generally are not accessible. Primary stations increase the pipe reliability because they can be useful in the following subjects.
They can prepare information about the pipe.
They can control the pipe leakage.
They can manage the pipe failure.
They are used for the pipe installation
They are used for the pipe operation and safety

Primary stations have a specific system or mechanism for any of above usages theses systems can be considered in some of primary stations with a different interval distances due to requirements. Theses mechanisms are not related so they are explained one by one in here. FIG. 28.

2-3-1) Primary Station Installation Usage

SSPP primary segments can be carried by tugboats from the coastal factory to the installation point. The tugboats pull the pipe with long strong cables which are connected to the primary stations. The pipe is bent after the junction points (primary stations) while it is being pulled. Therefore, the primary stations must be flexible enough to be bent properly due to the installation forces. Therefore, it can include flexible joints for this purpose. The welding process which connects two primary segments must be done offshore in a difficult condition. Therefore the pipe steel wall thickness can be increased in primary station to prove the welded joint strength and properties. FIG. 32.

2-3-2) Primary Station Operating and Safety Usage

Primary stations have safety valves to control the pipe internal (gas) pressure. These valves are like normal oil and gas safety valves. They can also have a sensitive diaphragm. If the internal pressure is increased the diaphragm will be ruptured and will release the gas to equalise the pressures and to protect the pipe structure. This rarely happens in the pipe's operating life unless the pipe is sent up to be floated for the maintenance.

2-3-3) Primary Station Fail Safe System

Primary station fail safe system is used to release the damaged segment and protect the other parts from failure. As it was mentioned before, the SSPP behaves like a wire rope, therefore, all the external applied forces are terminated to increase its tensile force. For example, if a ship's anchor pulls the pipe, the tensile force will be increased till the pipe breaks into pieces. If there is a big leakage or rupture, the damaged part sinks and pulls the pipe which also results in an increase in the tensile force.

2-3-3-1) Fail Safe System Components

The fail safe system constitutes the body of the primary station. Its parts are: two block valves, two lateral pipes, a middle ring and a weigh ring. The middle ring contains the weight ring and is welded between the two block valves. The two lateral pipes are welded to the valves and connect the system to the SSPP. FIG. 28.

2-3-3-1-1) Block Valves

The block valve is a gate valve with a simple structure. It has a gate which can slide in the valve casing. The gate is locked by a pin in the open position and a compressible spring always pushes it to be closed. The valves casings are located at the bottom of primary stations to keep it in balance. There are no control devices in theses valves. The SSPP's internal lines (vacuum and inhibitor) are made from brittle polymers where they pass through the block valves. When the valve's gate is being closed it breaks the internal lines to be able to block the SSPP. FIG. 28, FIG. 29, FIG. 30 & FIG. 31.

2-3-3-1-2) Lateral Pipes

Lateral pipes have two sections, one is the flexible part which is connected to the SSPP and has the same Submerge weight per length as SSPP and the other is the rigid part which is welded to the valves and it is lighter than SSPP and its buoyant force is much bigger than its weight. FIG. 28.

2-3-3-1-3) Middle Ring

Middle ring is the Fail Safe system's sensitive part. It has a specific failure area which includes a groove with a sealing cover. The groove resistant, due to the tensile force, is less than SSPP so if the pipe is torn it will fail from the middle ring's groove. FIG. 28 & FIG. 29.

2-3-3-1-4) Weight Ring

Weight ring is a heavy ring which its weight is chosen such that it cancels out the buoyant force of the two lateral pipes (rigid part). Therefore, when all Fail Safe systems' parts are jointed together, the whole system wet weight per length will be the same as SSPP. Weight ring sits free inside the middle ring without any connection. Weight ring is equipped with special pins which come out and sit on the top of valves' gates and lock them in open position. There are compressible springs between the weight ring and the valves. These springs are always pushing the valves to stay separated from the weight ring. FIG. 28 & FIG. 29.

2-3-3-2) Fail Safe System Function

If the pipe tensile force is increased, the middle ring will fail sooner than the other parts. When the middle ring is torn, its sealing cover keeps the joint seal for a short time. At this time the springs push the weigh ring to be separated from the valves so the pins come out and release the gates to be closed. Thus the valves close before the water comes in to the pipe. After the pipe breaks, the weight ring is released and sinks to the sea so the pieces ends (block valves) goes up due to the lateral pipe's buoyant force. It will keep the valve in the level which the water pressure is lower than the gas pressure. If the valve dose not seal the pipe completely, it is preferable for the gas to leak out the pipe rather than the water leaking in because the leaking system are not able to control the leakage.

2-3-4) Primary Station Leakage System

The leakage system is an optional system which is introduced in this section but it is a long system which is distributed in the whole SSPP and offshore stations and in many cases it is operated by the other system's equipments. Its three individual parts are: the SSPP internal lines, the vacuum absorber system and the inhibitor circulator system. The leakage system basic requirement is that the liquids are gathered in the primary station to be collected there. Therefore, the SSPP cables must be arranged to prepare a suitable slope for the pipe such that the primary stations become the lowest points. If the pipe profile's peak points are 25 meters higher than the primary stations the profile slop is about %2.5 (base on 1000 m interval distances) and it can be enough for the liquids (water, inhibitors, condensates) to move at the bottom of the pipe. The gas flow can help the liquids to move to the bottom of the pipe so the peak point location is chosen to be closer to the station which is not in the gas flow direction. FIG. 33.

2-3-4-1) SSPP Internal Lines

SSPP has two internal lines. They are small welded steel pipes which are laid in a small trench. Since internal lines have small diameters (1″-2″) they are flexible enough to deform easily with SSPP. Internal lines are continued through the whole SSPP to be connected to the offshore station. One of them is a vacuum line which is connected to the flaring system to be almost atmospheric (low pressure) and the other is an inhibitor line which is connected to the middle cylinder pump to be fed by inhibitors. The Internal lines are introduced to the pipe wall thickness in the pipe's Y branches and branched there to be connected to the middle cylinders by check valves. The check valves block the internal lines while the movable block valve (recheck the 2-2-4-1 section) is being used.

2-3-4-2) Vacuum Absorber System

The vacuum absorber simply collects the liquids. Its suction mechanism which is connected to the vacuum pipe includes a pit, a floater and a suction valve. If some liquids gather in the pit, the floater comes up and opens the valve so the vacuum line sucks the liquids and sends them to the flaring system till the floater falls and closes the valve.

2-3-4-3) Inhibitor Circulator System

The inhibitor (mostly used as gas anti hydration) is circulated into the pipe permanently. It is pumped into the inhibitor line, sprinkled and sprayed at peak points, flows at the bottom of pipe, collected by the vacuum line and is sent back to be re pumped.

Under normal conditions the inhibitor is circulated between the operating modules and the primary stations but if there is a leakage in the pipe the inhibitors must be sent to the command module (engine room) to be recovered there.

2-3-5) Primary Station Instruments

Primary station's instruments are gathered as a package in a seal box. These parts can be very helpful, however using them is optional. Primary station's internal and external areas have different types of instrument packages which are completely separated. The packages are able to work at high pressure and send the information wirelessly. They have a battery which can be recharged with the pipe's high voltage circuit. The Instrument packages are carried and installed by the pipe's pigs while they are kept by electrical magnets.

The external package has spherical shape. It can measure external (seawater) pressure, temperature and also velocity of currents around the pipe. It can send signals to the control rooms to clarify its exact situation in the ocean. External package is trapped in a casing at the top of primary station. It is lighter than water so if it is detached from the pipe or a pig, it comes to the sea surface and can be caught there. The internal package is sat in a specific area at the bottom of primary station. It can measure internal (gas) pressure, flow rate, temperature and water leakage.

2-4 Branches and Linking Stations

The GSTS is connected to the gas upstream and downstream industries by branches and linking stations. These stations and branches are used to send the gas from the pipe to the shore for consumption. They are also used to feed the pipe from an offshore or onshore gas sources. They can be categorised into the consuming and the feeding groups.

2-4-1) Feeding Stations

Feeding station is a compressor station which takes the gas from the producer (the gas resource), pressurises it to about 250-300 bars, and sends it through the feeding line. The station can be a coastal compressor plant which is supplied by a gas pipeline or can be an offshore platform, a FPSO or a Subsea system which connects the reservoir to the GSTS.

In feeding stations the gas hydrostatic pressure is positive (SSPP is lower than feeding stations) and it helps with the gas transfer from stations to the pipe. For example, if the gas average density is 100 kg/m³, the positive gas hydrostatic pressure in depth of 2000 m will be: ΔP=ρgh→ΔP=100×9.8×2000=1.96 Mpa≅+20 bar.

Feeding stations are able to cool the pressurised gas below the seawater temperature (2° C.) and separate the gas condensate to send dry and pure gas to the pipe.

2-4-2) Consuming Stations

Consuming stations are coastal valve stations. They take the gas form the pipe, match its pressure and give it to the consuming pipelines or networks. If the station input pressure is higher than the consuming system pressure, the gas pressure must be reduced there. In this case a turbo expander can be considered in the station to release pressure. Consuming stations have valves, metering system and pig receiver.

2-4-3) Feeding and Consuming Branch Lines

Feeding and consuming lines are steel offshore lines which are buried under or laid on the seafloor. Their length depends on the distance between the linking station and deep water (width of continent plateau). They can lay on seafloor for about 50-200 km. The SSPP and linking stations are located to make theses lines as short as possible.

These pipes can allow pigs to operate and usually don't have any valves or valve stations. SSPP has a high capacity of gas flow therefore it needs a large diameter feeding line (42″-56″) or more than one feeding line to be supplied. These lines are under high external pressure in deep water and high internal pressure in shallow water so they should have a thick wall and also external stiffener to avoid buckling in deep water.

The gas can be distributed between different consuming areas so there are more consuming lines than feeding lines. The gas is transferred through the consuming lines with the maximum possible velocity (less than the erosion velocity) to be able to be transferred with high flow rate in a small pipe. FIG. 35.

2-4-3-1) Feeding and Consuming Risers

Risers are flexible pipes (reinforced thermoplastic pipes) which are located between the offshore branch lines and the station's middle cylinders. The branch is anchored beside the station to be connected to the riser. The riser is designed to be suspended when it is operated with the average pressure but it can be lighter or heavier than water due to changes in the gas pressure.

Offshore stations location must be chosen properly to increase the riser length as much as possible. For example if the SSPP works between 2000 m and 2500 m depth, the seafloor with a depth of about 2700 m would be suitable area for the offshore stations.

Alternatively, the riser can be hung from a buoy instead of being sat on the seafloor. The buoy is connected by a cable to a base which is anchored to the seafloor.

The riser has a Y branch and a pair of block valves at its head (likes The SSPP) which are sat on the operating module's casing to be connected to the bottom of middle cylinders by two nipples. The connection equipments (Y branch, block valves, nipples) sizes are much bigger than the riser to be able to be controlled from the station. FIG. 34 & FIG. 35.

Chapter III

SSPP Installation, Construction and Operation

3-1 Introduction

In the first chapter it was assumed that the SSPP is ready in deep water in the ocean and its feasibility was considered relative to its function and stability. This assumption could be acceptable if the offshore industry had the experience of construction and installation of similar equipment and luckily such these activities mostly have been done before. The new required installation stage is explained here and there are suggestions for common construction and installation methods to prove them. SSPP operation is in general the same as the other pipelines but since it works under water its operation has specific issues which are explained here.

In this chapter first the SSPP installation methods are illustrated, a suggested construction method is explained for the SSPP and finally some of the SSPP operation issues are described.

3-2 SSPP Installation

SSPP installation includes all processes which must be carried out so that an SSPP segment (100 km) which is ready in the coastal mill can be taken and settled in deep water between two offshore stations.

The installation processes can be separated in to two phases. The first phase is the transportation phase. In this phase the pipe is carried from the coastal mill and connected between two offshore stations. The second phase is the submersion phase. In this phase the connected segment is submerged into deep water to reach the proper depth and settled under the water.

The density of the SSPP is less than that of seawater (specific gravity less than one) while it is in air and it will float on the water therefore specific tools are needed to submerge it during both the submersion and the transportation (if required) phase. These tools are special weights which are added to the pipe in the factory (construction phase). They are big in quantity, weight and length however they are renewable. This means they can be collected from the water and sent back to the factory after they have been used to install a pipe segment.

An installation tool unit includes a pair of long chain weights (similar to chain ballast with a length of about 2000 m), a saddle bag, a floating buoy, and a cable which connects the chains and buoy. The buoy lifting force is larger than the chains submerged weight therefore if the tool is released into the sea the buoy will float and the chains will sink and hang from it like a tail. FIG. 37 & FIG. 38.

Each specific length of pipe (120 m) needs a unit of installation tools so a set of installation tools used to install an SSPP segment (100 km) includes 830 units. Chains are gathered into a large saddle bag which is placed on the back of the pipe. Installation buoy are connected to gather with a strong cable and can be pulled by a tugboat on the sea surface.

The SSPP's ballasts (fixed, chain and buoyant) and cables are gathered and put in order in a box in the coastal factory. The box is fixed at the bottom of the pipe as a ballast package. The ballast packing is required because in practice it is not possible to carry the pipe while its ballasts are hanging from it. The box is actually the base ballast which is given a box shape to contain the other parts.

The ballasts packages are fixed to the pipe it can be fixed with a suggested following method, using wide thin ribbons which are wrapped around the pipe. The ribbon is made from longitudinal polymeric fibres which have high tensile strength but weak shear strength and can therefore be cut easily (similar to a piece of paper). A pair of thin and sharp cable is laid between the pipe and the ribbons along the pipe to be used as a cutter. FIG. 37 & FIG. 38.

3-2-1) Transportation Phase

Installation (transportation and fabrication) of SSPP can be done form a big lay barge (ship) like all other types of offshore pipelines. An old offshore pipeline installation method was that to fabricate a long piece of pipe on shore and pull it through the water for installation. This method is not common nowadays because of cost and practical difficulties but in here it is modified to be used for SSPP installation as an alternative option.

This optional phase starts where SSPP primary segments (1000 m) have been delivered from the coastal mill to the coastal shallow water and are ready to be carried. The SSPP must be carried under water to be protected from surface waves therefore the installation tools must keep it submersed at a depth of about 100 meters during the transportation phase.

In this phase the installation tools' cables are stretched between the buoys and the SSPP. The buoys float on the surface with the pipe hanging from them submerged to a depth equal to the cable length. The cable is jointed to the pipe. It can be jointed like ballasts package by a ribbon which is wrapped around the pipe. This ribbon can be cut in the next installation phase to separate the cable from the pipe and release the installation chains. FIG. 36

A few of (can be ten of them) primary segments (1000 m) can be pulled together with a couple of tugboats. The segments front heads (primary stations) are connected together by a beam (perpendicular to the pipes segments length about 90 m) to be kept with a proper distance (10 m) form each other. There is a similar beam which connects the segments back ends together. A tugboats (can be a bigger one) pull the pipes from the front beam trough the water and another tugboats pull them (obviously with a lower force) from the back beam in the opposite direction therefore the pipes segments are carried while they are fully stretched and they don't become entangled together. Installation buoys are connected together by strong cables and are pulled by the same tugboats pulling the pipe so the buoys are always above the specific pipe length (120 m) which they support. FIG. 36.

After the primary segments have been carried out to the installation location (between offshore stations) a primary segment separated from front and back beams. It is connected to an offshore station or head of an existing pipe by the back tugboat crew, after connection the front tugboat moves (1000 m) and pulls the remain segments then another segment is released from the beams and it is connected by the back tugboats. The process is continued till all the primary segments (10×1000 m) are connected together.

A pipe full segment (100 km) needs to be installed between two offshore stations to be able to be submerged. Therefore in this example ten sets of primary stations need to be installed by ten couple of tugboats. Since the full segments need to be completed as soon as possible due to the environmental condition then the installation process can be started from more than one point (for example two from offshore stations in opposite directions and two from the middle point toward the offshore stations) to do the process more quicker.

While primary segments are pulling through water the tugboats cables apply a lifting force to the front and back beams. This force must be cancel out by the beam's weight that the beams can keep the segments heads in proper depth (100 m). Some buoys are considered for the beams to cover their weight in static case.

The SSPP is planned to be transported in calm sea conditions but the pipe may need to be carried for thousands of miles which can takes more than a month therefore stormy conditions must be considered for pipe transportation. The SSPP is safe under water but the buoys and their cables must be designed to be stable in oceans' turbulent conditions.

3-2-2) Submersion Phase

SSPP can not installed (submerged) flooded and also can not installed with a high internal and external pressure difference therefore it needs a unique submerging process which is not dependents on transportation and fabrication process (by a lay barge or pulling the primary segments).

In this phase the SSPP segment is ready to be fully connected between two offshore stations. The end points of the segment (Y branches) are floated and are pulled by the offshore stations' winches. When they reach to the stations they sit on big wheels and are slid into the stations work shop to be connected to the system.

In the workshop the Y branch is opened (it was blocked for carrying) and is connected to the block valves and the middle cylinders. The segment is filled by gas after the connection. Two pigs with a batch of nitrogen are passed through the pipe to send the air out safely. After the pipe segment is fully filled by gas the workshop gate will open and send the pipe ends into the water. The pipe settles between two stations while it is submersed in shallow (100 meter) water. FIG. 40.

After the pipe has settled the ballast package must be realise in water. If the suggested connecting method is used the sharp cables (cutters) are pulled by speedboats from the stations. The cables cut the ribbons and release the ballasts into the water. This can be timed in a way to best control the pipe movement due to the ballast release. Other methods can be suggested for ballast release as well.

When the ballasts are released they will sink into the water. While they are sinking the pipe looses some weight and will come up and float on the sea surface for a short time. It is the last time that the pipe can be seen. The ballasts sink very soon and hang completely from the pipe segment so the pipe reaches its previous weight again and submerges into the water to reach the original depth (100 meters). The pipe settles in shallow water again while its ballasts are hanging from it. FIG. 41.

After the above process the installation tools cables must be disconnected from the pipe. It can be done as explained above if the suggested ribbons are used for jointing them. After disconnection the chain weights (installation tools chains) are released to the water. When the cables are separated, the pipe is not hung from the buoys any more so it sinks because it is heavier than water. While it is sinking the chains come out from the saddle bags and decrease the pipe weight so the pipe is submerging till its weight (density) becomes the same as seawater. Thus the pipe settles one more time in shallow water (for example at a depth of 150 meters). FIG. 42.

The pipe is now ready to be filled by gas to submerge into deep water. Pipe feeding requires a large source of gas so the installation should be started from the feeding coastal station. While the pipe is installed the new segments can be charged from the installed section. It is possible to use an LNG tanker as a source of gas to feed the pipe but this can be a difficult process.

In the feeding stage one of the middle cylinders is connected to the installed pipe and sends the gas through the feeding lines (offshore station riser) to the other middle cylinder which is connected to the new pipe segment. While the new segment is being filled by gas its weight (density) increases and it sinks into the water. At the same time the chains come out from the saddle bags and decrease the pipe weight (density). Therefore the pipe always is in equilibrium (has a same density as seawater) and submerges gently to the deeper water. The installation tool's chains weight per length is a specific function of gas density (like the pipe chain ballast) to keep the pipe internal and external pressure almost equal in the submerging phase.

When the new pipe segment reaches the proper depth, both its Y branches are trapped in the station's operating module and sit on their specific area. This way the block valves and middle cylinder are matched between the new segment and the installed pipe and connect them together.

3-3 SSPP Construction

The pipe construction has two phases: The first phase is manufacturing of the pipe elements such as steel pipe, concrete rings, flexible joint, ballast, etc and the second is constructing (fabricating) a long pipe by connecting these elements together.

The manufacturing phase consists of a large operation for a long SSPP (8000 km). However all elements of the manufacturing process are available in industry and no new technologies are used therefore further details of the manufacturing phase are not discussed in this chapter. It can be supposed that all the pipe's elements are made and ready in a warehouse to be sent to a lay barge for construction (fabrication) but if the installation method which is suggested in section 3-2-1 is considered, a special coastal factory is required which can construct and store hundreds of long primary segments (1000 m). The method of construction of these long pipe segments will be described.

The pipe primary segments can not be sent to the sea while they are being constructed because constructing these segments takes time and this would derange the area's shipping and transportations. Therefore the required number of (100) primary segments for a full segment length (1×100=100 km) must be constructed and be ready in the factory to be able to be sent out in a short time for installation. An SSPP construction mill is explained first to be able to clarify the construction process. The mill dimensions that are specified here are only given as an example.

3-3-1) SSPP Construction Coastal Factory

The SSPP mill is a huge factory. It is a coastal mill which looks like a big train station with many platforms and two ways out, one to the sea and one to the shore. The mill instead of the train grooves between platforms has long deep and wide canals which can be filled and emptied with water.

SSPP mill sections from sea to shore direction are: offshore sending platform, sending canal, leading lake, construction canals, test leading lake, and testing pipe. They are described in order as follows. FIG. 43.

3-3-1-1) Offshore Sending Platform

The offshore platform is the mill section which releases the pipe to the sea. It is a fixed platform which is installed in a suitable depth for the pipe to submerge (depth around 150 meters). The platform's structure and general facilities is the same as the other offshore platforms however when the pipe is carried from the mill the installation tool packages, ballast packages and buoys are connected to it therefore the platform has a special mechanism to allow it to send the pipe with the added equipment, this will be called a Sending Machine. FIG. 39.

The sending machine is not only is used in the platform but also in the coastal mill to move the pipe between the canals which have different elevation. The machine is made from many wheels on which the pipe can gently slide. The wheels are installed in two decks the lower one for passing the pipe and the upper for passing the installation buoys. The sending machine has a specific curve which is designed based on the pipe flexibility so the pipe can bend and deform properly when it is passing over the machine. FIG. 44 & FIG. 45.

3-3-1-2) Sending Canal

The Sending Canal is the canal which connects the construction mill to the sea. Its length is variable and depends on the distance between the mill and the sea. It can be very long (about 10 km) if the suitable area for making the mill is far from the sea.

The cannel has a trapezoid cross section. The pipe with its equipment must be able to pass through it so its minimum width is bigger than the pipe or the installation buoys diameter (about 8 meters) and its depth is deeper than the sum of the pipe diameter, buoy diameter and the primary station valves length (about 20 meters). The downstream part of the canal which is connected to the sea is deeper than the other parts due to the tide height. For example if the tide height is 10 meters then the downstream canal required depth will be 30 meters.

The sending canal is usually empty and is filled with water when an SSPP segment is complete and ready to be transferred. The canal can be filled and emptied by the mill pump station.

The area which is chosen to make the construction mill may have higher level than seawater for example 100 meters above sea level. It is not practical to build the sending cannel this deep (100 meters) therefore it must be made like stairs. This means the canal is separated to shorter sections which have different levels (each section has constant level).

These sections are connected together by sending machines. The machine can pull out the pipe from an upstream high level section and send it to a low level downstream section. The required tensile force to pull the pipe in canals can be high so the sending machines interval should be considered in a proper distances base on the pipe tensile strength.

3-3-1-3) First Leading Lake

The first leading lake is an area which the pipe's primary segments can be pulled from the constructing canals and led to the sending canal. This lake has a triangle shape with the constructing cannels connected to its base and the sending cannel connected to its apex. The lake depth is deep enough (about 20 meters) that a pipe segment with the added equipment (installation tools and ballasts) will be able to pass through it.

The first leading lake has a railway network at its bottom which connects the construction canal railways to the factories and warehouses so it is usually dry however it is connected to the mill pump station and can be filled or emptied with water.

3-3-1-4) Construction Canals

Constructing Canals are the largest section of the mill and all construction activities take place in this area. An option would be that the canals have the same length as an SSPP primary segment (1000 m) therefore the mill would have 100 canals so that a complete SSPP segment (100 km) can be constructed and stored in the mill. Construction cannels have the same width (8 meters) and depth (20 meters) as sending canals but they have a rectangular cross section. They have special supports that can hold the pipe's elements (pipe body, buoys, etc) safely.

A construction canal has gantry cranes which can move along it and cover the jointing process requirements. The canals have a railway at their bottom which is connected to a railway network. Electrical wagons can move in this network and carry pipe elements from the warehouses or factories to theses canals and handle all canal procurements. Construction canals have gates at their both ends so they can be filled and emptied with water independent of the leading lake conditions.

3-3-1-5) Second Leading Lake

The second leading lake is an area where the pipe's pieces can be pulled from the construction canals and led to the testing pipe to be tested. The second leading lake is located between the construction canals and the testing pipe. It is the same as the first leading lake but it is shallower (depth of about 5 meters) and usually is full.

3-3-1-6) Testing Pipe

The testing pipe is a steel pipe which can be pressurised by water to apply an external pressure to a piece of SSPP for testing. It is a long pipe (200 meters) and has a large diameter (about 4 meters) to be able to contain the SSPP. It is located at the end of the mill. In general the pipe pieces can be pulled between different areas in the mill by strong winches.

3-3-2) SSPP Construction Process

This phase is started in the construction canals. The wagons take the pipe elements (steel pipes fitted with internal concrete rings, etc) to the canals and gantry cranes lift them and put the elements on their supports and fitters and welders join them together. There are 100 canals so there can be 100 construction lines, this also helps increase the construction speed and save time.

The jointing process is continued till the piece of pipe finds the proper length (200 m) to be tested. Then two caps (the caps have a manhole) are welded to the pipe ends and make it seal. Now the pipe is ready to be tested. First a hydrostatic test (like the other pipelines) is carried out base on internal pressure. After that the canal gate is opened and it is filled with water. The piece of pipe is floated (it is lighter than water) and pulled by a winch to be passed through the lake and taken into the test pipe. The test pipe cap is closed and it is filled with water and pressurised to test the piece of pipe base on external pressure. After the test the piece of pipe is pulled to its canal.

The above procedure is continued till an SSPP primary segment is completed in a construction canal (depends on testing pipe length). When pieces of pipe (5×200 meter) are ready they are laid back to back in a canal. The caps are cut from the pipe ends and a steel pipe is welded instead in their place to connect the pieces together. These joints are the golden joints. It means they do not need the pressure tests because they have higher mechanical property and higher sealing quality than the SSPP structure. The first and the last cap are kept on the pipe to keep the primary segment seal.

After the above step the primary segment must pass a tensile test. To do this the construction cannel is filled with water and the pipe segment is set afloat. Then it is pulled from its ends by strong winches to be checked for the required tensile strength.

The pipe tests are now complete and the additional equipment (ballasts package, installation package and buoys) must be connected to the pipe. In this phase ballasts package are fixed to the pipe bottom and the saddle bags are placed on the pipe pack after that the cables are fixed to the pipe and finally the buoys are joined to the top of the pipe by a pin type junction.

When all (100) primary segments are ready in the construction canals, the pipe can be sent out from the mill. This stage takes several days so calm weather is needed and coastal activities may need to be controlled during this period. The primary segment which has the ballast and installation packages is heavier than water but is attached to the buoys and can be lifted up by the buoys when the canal is being filled with water.

The primary segments are pulled in order by the mill winches and are passed through the lake and introduced to the first sending machine to be moved to the sending canal. The pipe is taken out from the water while passing over the machine. The primary segment caps are retained till they reach the offshore platforms. In the platform the caps are cut, primary stations are jointed to the pipe ends then the caps are welded to the primary stations to make the pipe seal again.

While the pipe is being passed through the platform the joints between buoys and the primary segments are reconnected therefore the pipe sinks after the platform till the cables are stretched completely and the pipe is suspended from the buoys.

The above construction method is practical however other construction methods can be suggested also. The discussed method is considered only to demonstrate the SSPP construction feasibility and not to find the most suitable construction method.

3-4 SSPP Operation

Generally operating a pipeline is much simpler than the other oil and gas industry sections operation. SSPP like other pipelines has a simple operation. It is primarily operated and controlled from the coastal offices. Operating, dispatch, maintenance, inspections, etc are done by a small group of people who can service a long section of pipe. The team is based in the coastal office and may be commissioned to stay in the offshore station temporarily. SSPP can be run like the other pipelines and there are not many new issues to be considered for its operating feasibility.

Three different operating, maintenance and inspection issues which can be specific to SSPP are explained here. The first issue is system capability in regards to variable gas demand, the second is the removal of the pipe from deep water and the third is SSPP pigs.

3-4-1) SSPP Capabilities

The gas consumption rate is variable in different months of the year so the pipe capacity must be changed due to the gas demand rate. In winter when the demand rate is high the SSPP can be operated in its lower level with high pressure to have high capacity and in summer when the demand rate is low it can be operated in its upper level with low pressure saving energy in the feed compressor onshore station. The pipe transmission capacity can also be increased or decreased by running more or less compressors in the offshore stations.

SSPP can be used not only for gas transportation but also as a small gas reservoir. For example if there is a 4000 km SSPP with a capacity of 200 Million cubic meters per day which is working between 2000 m and 2500 m depth, it can save about 750 million cubic meters of gas between its highest and lowest operating pressure. This means the pipe can hold almost 4 days of gas consumption without any input and this advantage can be helpful for the gas dispatching system.

SSPP can be fed constantly while its gas is consumed variably. It can cover the different rate of gas consumption between days and nights. When the gas consumption is higher than the feeding rate the gas is depressurised and the pipe comes up and when the gas consumption is lower than the feeding rate the gas is pressurised and the pipe goes down.

3-4-2) SSPP Release

The pipe would normally is never needed to come up and be floated on the sea surface during its life but in the special case of it becoming damaged it can be sent up to the surface by the following process to be repaired.

A spare segment must be carried and installed in place of the damaged pipe and be used as a bypass. After that the damaged pipe's gas should be released and the pipe must be filled with air by pigs. When the segment has been filled by air completely it is depressurised so the pipe becomes lighter and it comes up till it reaches the upper limit border (it is kept by the base ballast).

If the depressurising is continued the air density will drop and buoyant force will lift the base ballasts from the sea bed and after that there is nothing to keep the pipe submersed so the pipe comes up to the surface without any control. While the pipe is coming up its external pressure decreases and becomes lower than the internal pressure. In this condition tensile stresses can appear in the concrete cylinder so to protect the pipe from rupture the primary station safety valves are opened and send the air to the water to keep the external and internal pressure at equilibrium.

When the pipe segment is floated on surface it can be repaired but it will need the installation tools to be re-submerged in the water therefore special vessels need to be considered for this reason. The problem is that the job must be done in a short period of time because if the surface conditions do not stay calm the pipe can be easily damaged.

3-4-3) SSPP Pigs

SSPP pigs are very different from usual pipeline pigs. They can not move due to the difference of pressure so they have an electrical runner. The pipe has an internal and an external rail along it to guide the pigs and provide the electricity for them to move inside and outside the pipe. SSPP pigs are primarily meant to be used for batching, viewing, inspection, and may be used for cleaning, installation and measurement. Batching pigs are used in pairs to replace air and gas in the pipe. They have a sealing ring which can cover the pipes internal area and push the gas or air out. They are always passed through the pipe with a batch of nitrogen at the middle. This is done to avoid the mixing of gas and air. These pigs can also be used as cleaning pigs to remove hydrates from the pipe. For this purpose the pig has an electrical heating system at its head to vaporise the hydrate crystals. Batching-cleaning pigs are rarely used in the pipe operation. Viewer pigs are cameras with strong lights which are able to work in high pressure conditions. Viewer pigs are small devices which can moves on the rails fast and relay useful information about the pipe's inside and outside conditions. They are especially used for leakage inspection. These pigs can also be used to carry and install the primary station instrument packages (if they are used in the system). They also can include measurement instruments to report the pipe physical specification. The similar intelligent (as Magnetic flux leakage (MFL) and ultrasonics) pigs which are used foe pipeline inspection can be used for SSPP inspection. Their structures must be modified to be able to do the inspection from outside of SSPP because the internal area is covered by a thick concrete layer.

Ultrasonic mechanism is better for SSPP external inspection because the pipe is submerged in water.

Conclusion

The natural gas market will be developed rapidly in the near future. Therefore gas transport technology will be an important field which should be considered more imaginatively. This work is the first attempt to provide a novel gas transport method in terms of safety, high capacity performance, and cost.

The ocean depths remain one of the least explored environments. Although potential difficulties have been identified and addressed, there may yet be unidentified obstacles that will have to be considered as they arise.

There are a number of novel concepts that have been introduced in this report, many of which have not seen formal evaluation and testing. Comprehensive research plans are available with required expertise and equipment included.

The introduction of the GSTS here is intended to provide a sound and thought provoking basis for further detailed investigation rather than for immediate industry development. Realistically, comprehensive research is required in order to make a real model before the GSTS would be ready to be introduced into the industry. However the basic concepts, evidence and calculations developed in the paper is testimony to the feasibility and importance of the GSTS in the future of the gas industry.

1. A gas subsea transmission system which uses a submersible suspension pressure-equaliser pipeline and submergible offshore stations to transport gas through marine distances The pipeline is submerged and suspended in deep water and able to equalize its internal and external pressure along its whole length. It means the pipe can equalize its external hydrostatic pressure with its internal variable operating gas pressure by changing its depth. Obviously by chance the internal content pressure and external hydrostatic pressure can be equal in some areas along any offshore pipelines depending on the operating condition. The claimed pipe is unique because it can equalise the gas internal and hydrostatic external pressure along its whole length. It should be noted that all offshore pipeline's external pressure partially cancels out the internal pressure due to operating conditions but this phenomenon is not controllable and cannot have a specific value The claimed pipeline can be designed such that it can cancel any required amount of internal gas pressure with the hydrostatic external pressure along its length while the internal pressure is varying In other words the pipe can be designed to keep the internal and external pressure difference constant to any required value along its whole length.

2. A submersible suspension pressure-equaliser pipeline in claim 1 has a mooring system that makes the pipe stable and equalizes the pipe internal and external pressures The mooring system does this by adjusting the pipe depth depending upon the gas internal pressure The mooring system connects the pipeline to seafloor by cables The cables have chain shape parts (weights) which are called as chain ballast Some parts of chain ballast are sitting on the seafloor The function of mooring system can be clarified by example 1 ______. Example 1 Suppose that a rigid ball (steel ball) is hung from a chain in a deep pool and it is submersible in a specific depth while some part of the chain is sitting on the floor If some more air is fed to the ball buoyant force of ball is not changed because it is rigid and there is no change in its volume However as the air pressure increases the ball becomes heavier and it's submerge weight (dry weight minus buoyancy) increases so the ball sinks and allows the chain to sit on the floor until the new lifting force (negative submerge weight or buoyancy minus dry weight) becomes equal to the new chain weight. The new equilibrium point is deeper than the old one so the hydrostatic pressure around the ball in this point is higher than the first equilibrium point. The above example shows that an increase in the ball air (internal) pressure produces an increase in the hydrostatic (external) pressure around it. Therefore if the chain weight per unit length is a suitable function of air density base on pressure changes, the increase in hydrostatic (external) pressure can be the same as the increase in gas (internal) pressure End of example 1 ______. The mooring system chain ballast weight per unit length can be selected such that it can accommodate the changes in the pipe depth with changes in gas density or pressure. This specific weight per length is a function of internal gas density changes due to the changes in the gas pressure. The mooring system chain ballast is novel and different from other identical available systems because it has a unique weight per length for any specific depth. This unique specification can be clarify by example 2. This example is just for explanation and valid for a specific operating case where gas and environmental temperature is constant and the pipe is designed to have an exact equal external and internal pressure The present calculation can be modified to accommodate any other operating conditions ______. Example 2. If it is assumed that the chain ballast is hung vertically and A and B are two points one unit length apart on the chain ballast and A is above B Following physical characteristic are considered ______.
D_{A}=Depth of Pipe Centre Line below Sea Surface while Point A is touching the see bed ______.
D_{B}=Depth of Pipe Centre Line below Sea Surface while Point B is touching the see bed ______.
P_{A}=Hydrostatic Pressure at Depth D_{A} ______.
P_{B}=Hydrostatic Pressure at Depth D_{B} ______.
ρ_{A}=Gas Density at Pressure P_{A} (Note that the gas temperature is assumed constant and equal to the environment temperature) ______.
ρ_{B}=Gas Density at Pressure PB (Note that the gas temperature is assumed constant and equal to the environment temperature) ______.
V_{Gas}=Gas volume per unit length of pipe ______.
W_{Last}=Weight of AB Segment of Chain Ballast per Unit Length of the Pipe ______.
W_{Last} can be calculated as follow ______.
W_{Last}=(ρ_{A}−ρ_{B})×V_{Gas} end of example 2______.

3. A mooring system in claim 2 can have chain shape buoys instead of chain shape weights whose lifting force per length is function of gas density due to gas pressure change Their function is the same as pipe's mooring system function in claim 2.

4. A submersible suspension pressure-equaliser pipeline in claim 1 has a specific structure to resist against pipe buckling. The buckling is happened due to external pressure and the pipe bending Pipe is reinforced by thick rigid internal rings. The rings are separate elements which are fixed into the pipe along its entire length A layer of compressible material is fitted between these internal rings.

5. A gas subsea transmission system in claim 1 includes submergible offshore stations that control and operate the pipeline. These stations are special because they can be submerged during the operation and can be floated for access. They are stabilized in sea by their mooring system. The mooring system cable are also providing a means of connection between offshore station and the pipe.

6. An offshore station in claim 5 has some valves which are connected to the pipe. Theses valves have a unique connection mechanism. They have a groove in their connecting surface which traps some water. Valves are connected to the pipe first by a magnetic system then the trapped water is pumped out and high external hydrostatic force provide a tight joint and connect the valve to the pipe.

7. An offshore station in claim 5 has a mechanism which is able to collect the liquids from the pipe and send them to the environment. For this reason the pipe in claim 1 has few small diameter internal pipes though which the collected liquids are transferred.

8. A submersible suspension pressure-equaliser pipeline in claim 1 has fail safe mechanisms along its length. The mechanism includes two block valves. The joint strength between these valves is weaker than the pipe strength therefore failure due to tensile forces happens at this joint. These valves are automatically closed before the pipe goes to pieces and block the pipe.

9. A gas subsea transmission system in claim 1 has some special mechanism which can block the pipe. These tools can be introduce into the pipe from offshore stations in claim 6. They are special vehicles which can moves inside the pipe. They can inflate a balloon shape devices in the pipe to block the pipe.

10. A submersible suspension pressure-equaliser pipeline in claim 1 is transported through the sea by specific method. It is submerged while it is transported to be protected from environmental condition. It is hung from buoys and is carried by two boat at its both ends. One boat is pulling the pipe head and the other boat stretches the pipe end in the opposite direction.

11. A submersible suspension pressure-equaliser pipeline in claim 1 is installed and submerged by special tools. These tools keep the pipe's external and internal pressure equal while it is submerged. They have a special chain shape parts with a specific weight per length. Their function is the same as pipe's mooring system function in claim 2.

12. A submersible suspension pressure-equaliser pipeline in claim 1 is constructed in a special coastal factory. The factory includes many canals trough which that a specific length of pipe is constructed and transferred. The canals are filled with water and the pipe floats to be carried.
